(19) United States
(12) Patent Application Publication
(10) Pub. No.: US 2025/0130513 A1
(43) Pub. Date: Apr. 24, 2025

(54) ELECTROPHOTOGRAPHIC PHOTORECEPTOR AND IMAGE-FORMING APPARATUS INCLUDING THE SAME

(71) Applicant: SHARP KABUSHIKI KAISHA, Sakai City (JP)

(72) Inventors: Akiko KIHARA, Sakai City (JP); Kohichi Toriyama, Sakai City (JP)

(21) Appl. No.: 18/920,045

(22) Filed: Oct. 18, 2024

(30) Foreign Application Priority Data
Oct. 19, 2023 (JP) 2023-180357

(51) Int. Cl. G03G 5/087; G03G 5/05

(52) U.S. Cl. CPC G03G 5/087; G03G 5/0564

(57) ABSTRACT

An electrophotographic photoreceptor having at least a photoreceptive layer, which comprises one or more layers, on a conductive base, wherein a surface layer of the photoreceptive layer contains a binder resin and silica particles, wherein the silica particles have a specific number average primary particle diameter and are contained at a specific ratio with respect to a total solid content in the surface layer, wherein the binder resin is made of a specific polycarbonate resin, wherein an area at a center part of a charged area in an axial direction of the electrophotographic photoreceptor on a surface of the surface layer of the photoreceptive layer has a specific average spacing Sm of irregularities, wherein the surface of the surface layer of the photoreceptive layer has a specific contact angle to pure water.

### BACKGROUND OF THE INVENTION

### Field of the Invention

The present disclosure relates to an electrophotographic photoreceptor and an image-forming apparatus including the same.

### Description of the Background Art

Electrophotographic image-forming apparatuses, which form images using electrophotographic technology, are widely used in digital copiers, printers, facsimile machines, and others.

An electrophotographic photoreceptor (hereinafter also referred to as a “photoreceptor”) used in an electrophotographic process is configured to comprise a photoreceptive layer containing a photoconductive material on a conductive base (also referred to as a “conductive substrate”).

Currently, research and development of photoreceptors with a photoreceptive layer mainly comprising an organic photoconductive material (also referred to as an “organic photoreceptor”) is progressing, and these photoreceptors are the mainstream to be used for image-forming apparatuses in practical use.

However, the organic photoreceptors have a disadvantage that their surfaces are easily worn by contact with a cleaning blade and the like due to the nature of organic materials. In addition, with a recent increase in contact charging systems using roller charging and also with longer life, smaller size, and higher speed of image-forming apparatuses, organic photoreceptors are exposed to severe conditions that cause their surfaces to be worn more easily.

To address such a problem of wear on the photoreceptor surfaces, attempts have been made to improve wear resistance by, for example, providing a surface protective layer using a cured and highly print resistant resin. However, as the print resistance (print durability) of the photoreceptive layer increases, and the photoreceptor surface becomes more difficult to be refreshed (self-restored), damage to peripheral components such as the cleaning blade increases, and a risk of image deterioration increases such as image deletion caused by adhesion of discharge products in an environment of high temperature and high humidity. There was also another problem that the formation of the surface protection layer complicates a production process of the photoreceptor and increases costs of the photoreceptor itself, making the photoreceptor too expensive to be used in widespread machines.

In a photoreceptor that does not have a surface protective layer and has a charge transporting layer as an outermost surface layer of the photoreceptive layer, the charge transporting layer wears out and reaches the end of its life. Therefore, in order to suppress this wear, methods have been proposed in which a binder resin with a structure that is resistant to mechanical fatigue is adopted.

For example, a method has been proposed to improve print resistance of a photoreceptor by introducing a polycarbonate resin with a specific biphenyl structure as a binder resin in a charge transporting layer of an outermost surface layer of the photoreceptor.

However, the binder resin of this prior art has a problem such as poor adhesion to a charge generating layer, resulting in poor charge injection from the charge generating layer and a higher residual potential than when a usual polycarbonate resin is used.

Furthermore, similar to the above-mentioned prior art, a method has been proposed in which a polycarbonate resin having a specific biphenyl structure is introduced onto an outermost surface layer of a photoreceptor, and silica particles are further added thereto so as to improve wear resistance (abrasion resistance) and oil crack resistance.

### SUMMARY OF THE INVENTION

According to the above-mentioned prior art, the addition of the silica particles improves the adhesion between the photoreceptive layers and also improves, in a laminated photoreceptive layer, the adhesion between the charge generating layer as a lower layer and the charge transporting layer as an upper layer.

However, the inventors of the present invention have confirmed that such improvement in adhesion is greatly influenced by a dispersion state of the silica particles and that if the dispersion state is insufficient, the improvement in adhesion to the lower layer is insufficient, with the result that a residual potential increases due to repeated fatigue, and stable image characteristics cannot be obtained over the long term.

More specifically, if silica particles with a number average primary particle diameter exceeding 50 nm are added to an outermost surface layer of a photoreceptive layer, there is a significant adverse effect on residual potential, while if silica particles with a smaller number average primary particle diameter are added, there is a tendency to reduce an effect of improving print resistance (printing resistance).

In other words, it was difficult for the above-mentioned prior art to achieve high wear resistance in parallel with maintenance of sensitivity characteristics and formation of high-quality images, by using the polycarbonate resin having the specific biphenyl structure and the silica particles in the surface layer of the photoreceptive layer.

An object of the present disclosure is to provide an electrophotographic photoreceptor that is capable of achieving simultaneously high wear resistance (abrasion resistance), maintenance of sensitivity characteristics, and formation of high-quality images, and also provide an image-forming apparatus equipped with the electrophotographic photoreceptor.

As a result of diligent studies to solve the above problems, the inventors of the present invention have found that the above-mentioned problems can be solved by dispersing (scattering) silica particles in an outermost surface layer of a photoreceptive layer that uses a polycarbonate resin having a specific biphenyl structure as a binder resin and optimizing a dispersion state thereof, and have thus completed the present invention.

The present disclosure provides an electrophotographic photoreceptor having at least a photoreceptive layer, which comprises one or more layers, on a conductive base, wherein a surface layer of the photoreceptive layer contains a binder resin and silica particles,
wherein the silica particles have a number average primary particle diameter of 30 nm or less, and are contained at a ratio of 7 to 20 mass % (% by mass) with respect to a total solid content in the surface layer, and
wherein the binder resin is made of a polycarbonate resin represented by general formula (I) (shown in FIG. 6) comprising structural units (A) and (B),
   wherein R11, R12, R21, and R22 are identically or independently a hydrogen atom, an alkyl group having 1 to 3 carbon atoms, or a fluoroalkyl group having 1 to 3 carbon atoms; X is a phenylene group, a biphenylene group, a naphthylene group, an alkylene group having 1 to 3 carbon atoms, or a cycloalkylene group having 3 to 6 carbon atoms; and m and n are exponents that meet the following relationship: 0.3≤m/(n+m)≤0.55, wherein a 4 mm-wide area at a center part of a charged area in an axial direction of the electrophotographic photoreceptor on the surface of the surface layer of the photoreceptive layer has an average spacing Sm of irregularities of 15 to 60 μm as defined in JIS-B-0601 (1994),
   wherein the surface of the surface layer of the photoreceptive layer has a contact angle of 85 to 94° to pure water.

The present disclosure provides an image-forming apparatus comprising at least: the above-described electrophotographic photoreceptor; an electrifier for electrifying the electrophotographic photoreceptor; an exposer for exposing the electrified electrophotographic photoreceptor to form an electrostatic latent image; a developer for developing the electrostatic latent image to form a toner image; and a transferer for transferring the toner image onto a recording medium.

The present disclosure provides an electrophotographic photoreceptor capable of achieving simultaneously high wear resistance, maintenance of sensitivity characteristics, and formation of high-quality images, and also provides an image-forming apparatus provided with the electrophotographic photoreceptor.

### BRIEF DESCRIPTION OF THE DRAWINGS

FIGS. 1A and 1B show schematic illustrations of a mechanism in which adhesion of a structural layer of a photoreceptor is improved by blending (scattering) silica particles having a specific number average primary particle diameter: FIG. 1A illustrates a coating film formed of a charge transporting layer on a charge generating layer; and FIG. 1B illustrates the charge transporting layer on the charge generating layer after heat treatment.

FIGS. 2A to 2D show schematic illustrations showing a mechanism in which a surface spacing of irregularities in a surface layer of a photoreceptor, which reflects a dispersion state of silica particles, affects adhesion of a structural layer of the photoreceptor: FIG. 2A illustrates good dispersion; FIG. 2B illustrates poor dispersion; FIG. 2C illustrates the silica particles having a large number average primary particle diameter; and FIG. 2D illustrates the silica particles having a small number average primary particle diameter.

FIGS. 3A and 3B show schematic illustrations showing adhesion of a structural layer of a photoreceptor: FIG. 3A illustrates that the structural layer is dry; and FIG. 3B illustrates that adhesion is low.

FIG. 4 is a diagrammatic cross-sectional view showing a configuration of a main part of a photoreceptor 1 according to the present disclosure.

FIG. 5 is a schematic side view showing a configuration of key components of an image-forming apparatus 100 according to the present disclosure.

FIG. 6 is a structural formula of general formula (I).

FIG. 7 is structural unit (A1).

FIG. 8 is structural unit (B1).

FIG. 9 is structural unit (B2).

FIG. 10 shows fluorine-containing alcohols (F1) to (F4).

FIG. 11 shows compounds (1) to (4) of a polycarbonate resin.

FIG. 12 shows polycarbonate resin compounds (5) to (8).

FIG. 13 shows polycarbonate resin compounds (9) to (11).

FIG. 14 is a Table showing substituents and chain end groups of polycarbonate resin compounds (1) through (11).

FIG. 15 shows a structural formula of general formula (A).

FIG. 16 shows the structural formula of titanyl phthalocyanine.

FIG. 17 shows the structural formula of compound (A).

FIG. 18 is a Table showing main constituent materials for a surface layer (charge transporting layer) of each of photoreceptors prepared in Examples and physical properties of the materials and also surface properties of the surface layer.

FIG. 19 is a Table showing main constituent materials for a surface layer (charge transporting layer) of each of photoreceptors prepared in Comparative Examples and physical properties of the materials and also surface properties of the surface layer.

FIG. 20 is a Table showing evaluation results of Examples.

FIG. 21 is a Table showing evaluation results of Comparative Examples.

### DESCRIPTION OF THE PREFERRED EMBODIMENTS

An electrophotographic photoreceptor according to the present disclosure is an electrophotographic photoreceptor characterized by having at least a photoreceptive layer,

which comprises one or more layers, on a conductive base,
wherein a surface layer of the photoreceptive layer contains a binder resin and silica particles,
wherein the silica particles have a number average primary particle diameter of 30 nm or less, and are contained at a ratio of 7 to 20 mass % (% by mass) with respect to a total solid content in the surface layer, and
wherein the binder resin is made of a polycarbonate resin represented by general formula (I) (shown in FIG. 6) comprising structural units (A) and (B),
   wherein R11, R12, R21, and R22 are identically or independently a hydrogen atom, an alkyl group having 1 to 3 carbon atoms, or a fluoroalkyl group having 1 to 3 carbon atoms; X is a phenylene group, a biphenylene group, a naphthylene group, an alkylene group having 1 to 3 carbon atoms, or a cycloalkylene group having 3 to 6 carbon atoms; and m and n are exponents that meet the following relationship: 0.3≤m/(n+m)≤0.55, wherein a 4 mm-wide area at a center part of a charged area in an axial direction of the electrophotographic photoreceptor on the surface of the surface layer of the photoreceptive layer has an average spacing Sm of irregularities of 15 to 60 μm as defined in JIS-B-0601 (1994),
   wherein the surface of the surface layer of the photoreceptive layer has a contact angle of 85 to 94° to pure water.

In the following, constituent features that characterize photoreceptors according to the present disclosure will be described; and then (1) the photoreceptors and (2) image-forming apparatuses in which the photoreceptors are respectively installed will be described. Embodiments and Examples to be described below are only specific examples of the present invention; and the present invention is not limited thereto.

### Silica Particles

Silica particles to be contained in a surface layer of a photoreceptive layer of the photoreceptors are, for example, dry silica particles and wet silica particles.

Examples of the dry silica particles include: combustion method silica (fumed silica) obtained by burning a silane compound; and explosion method silica obtained by explosively burning metallic silicon powder.

Examples of the wet silica particles include: wet silica particles obtained by neutralization reaction of sodium silicate with a mineral acid (precipitation method silica synthesized and agglomerated under alkaline conditions and gel method silica particles synthesized and agglomerated under acidic conditions); colloidal silica particles (silica sol particles) obtained by alkalizing and polymerizing acidic silica acid; and sol-gel method silica particles obtained by hydrolyzing an organosilane compound (for example, alkoxysilane).

Among these, from the viewpoint of suppressing image defects due to the generation of residual potential and other deteriorated electrical properties (suppressing deterioration of fine line reproducibility), the combustion method silica particles, which have few silanol groups on the surface and a low (less) porous structure, are desirable as the silica particles. The silica particles can also exhibit the best electrophotographic properties when treated with dimethyldichlorosilane or hexamethyldisilazane.

### Number Average Primary Particle Diameter of Silica Particles

The inventors of the present invention have found from a laminated photoreceptive layer of a photoreceptor that in a case where a surface layer of the photoreceptive layer contains silica particles with a number average primary particle diameter of 30 nm or less (small-diameter silica), and the silica particles maintain a favorable dispersion state in the surface layer, adhesion between a charge transporting layer and a charge generating layer is improved, and also an increase in Vr due to repeated electrical fatigue is suppressed.

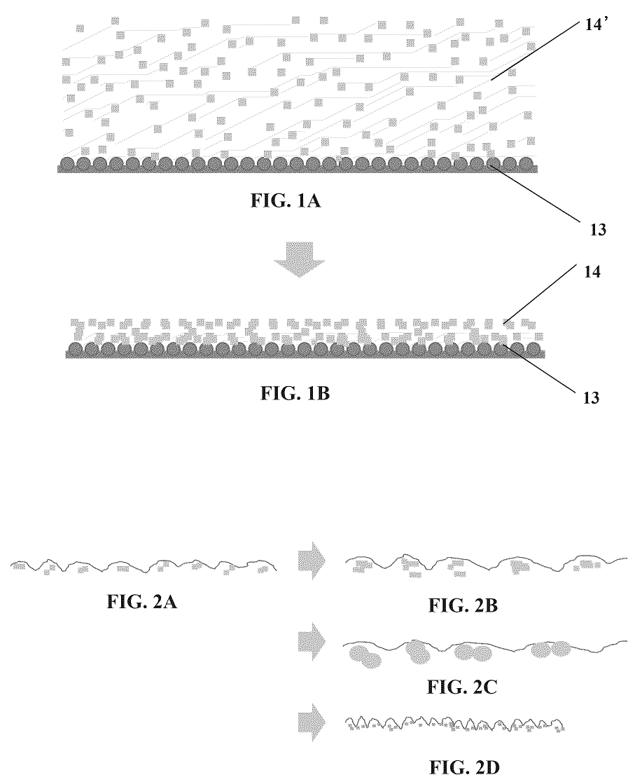

FIGS. 1A and 1B show schematic illustrations of a mechanism in which adhesion of a structural layer of a photoreceptor is improved by blending silica particles having a specific number average primary particle diameter: FIG. 1A illustrates a coating film formed of a charge transporting layer on a charge generating layer; and FIG. 1B illustrates the charge transporting layer on the charge generating layer after heat treatment.

By dispersing the silica particles in the photoreceptive layer with good dispersibility within a range according to the present disclosure, surface areas of the silica particles are increased; and a state in which intermolecular forces are active is maintained. By adding the silica particles to a charge transporting layer coating liquid, the coating liquid becomes thixotropic, and when the coating liquid is applied onto the charge generating layer, the coating liquid penetrates into gaps of pigments on the surface of the charge generating layer (CGL) (FIG. 1A). When this is heat-treated, the solvent evaporates; and the resin solidifies (hardens) (FIG. 1B). Here, it is presumed that if the silica particles are present in the charge transporting layer (CTL), a distance between the silica particles after evaporation becomes smaller, and activity of the intermolecular forces increases significantly, allowing the charge transporting layer to adhere to the charge generating layer, and increasing adhesion therebetween. It is presumed that the increased adhesion of the charge transporting layer to the charge generating layer promotes injection of holes into the charge transporting layer by generated carriers. How to measure a number average primary particle diameter will be specifically described in Examples.

The silica particles in the surface layer of the photoreceptive layer of the photoreceptors according to the present disclosure have a number average primary particle diameter of 30 nm or less.

The smaller the number average primary particle diameter of the silica particles, the better the adhesion, but the less the advantage in print resistance (printing durability). The larger the number average primary particle diameter of the silica particles, the less the advantage in adhesion, and the less the benefit for reducing residual potential. In particular, if the number average primary particle diameter of the silica particles exceeds 30 nm, the contribution of particle-to-particle interaction may become lower, and the adhesion effect may decrease. The desired number average primary particle diameter of the silica particles is 10 to 20 nm, as this diameter maintains the best balance of properties, and more preferably 15 to 20 nm; and 16 nm is especially preferred, which is the particle diameter of the silica particles used in Examples.

### Dispersion State of Silica Particles

The inventors of the present invention have also confirmed that a dispersion state of the silica contributes significantly to adhesion to an underlying layer and to print resistance (print durability).

FIGS. 2A to 2D show schematic illustrations showing a mechanism in which a surface spacing Sm of irregularities in a surface layer of a photoreceptor, which reflects a dispersion state of silica particles, affects adhesion of a structural layer of the photoreceptor: FIG. 2A illustrates good dispersion; FIG. 2B illustrates poor dispersion; FIG. 2C illustrates the silica particles having a large number average primary particle diameter; and FIG. 2D illustrates the silica particles having a small number average primary particle diameter.

FIG. 2A shows that ten-point surface roughness Rz and surface spacing Sm of irregularities of the surface layer are both small, indicating a good dispersion state.

FIG. 2B shows that Rz and Sm are both large, indicating insufficient dispersion of the silica particles in the surface layer.

FIG. 2C shows that the silica particles have a large particle diameter; Sm is large; and contribution of particle-to-particle interaction is less; and thus adhesion effectiveness is low.

FIG. 2D shows that a particle diameter of the silica particles is too small, and dispersion is improved, allowing intermolecular forces to become stronger, Sm to become smaller, and an improvement range of Vr to become larger; however, an effect of print resistance is reduced. As described above, the inventors of the present invention have confirmed that the “average spacing of dispersed silica particle” correlates with the “average spacing Sm of the surface irregularities of the photoreceptive layer.”

### Surface Conditions of Surface of Photoreceptive Layer

A 4 mm-wide area at a center part of a charged area in an axial direction of the electrophotographic photoreceptor on a surface of the surface layer of the photoreceptive layer has an average spacing Sm of irregularities (projections and depressions) of 15 to 60 μm as defined in JIS-B-0601 (1994).

If the dispersibility of the silica particles is optimized, and the average spacing Sm of the dispersed silica particles is adjusted to be greater than 15 μm and 60 μm or less, a favorable tendency (of surface conditions) is observed.

If the average spacing Sm of the irregularities (humps and bumps) is less than 15 μm, the intermolecular forces of the silica particles become too strong, causing the photoreceptive layer to lose flexibility, and reducing the print resistance effect. If the average spacing Sm of the irregularities (asperities) exceeds 60 μm, the contribution of the interaction between the particles becomes less, and the effect on adhesiveness may decrease.

The average spacing Sm of the irregularities (unevenness) is preferably 25 to 60 μm, and more preferably 35 to 55 μm.

It is desirable that the 4 mm-wide area at the center part of the charged area in the axial direction of the photoreceptor on the surface of the surface layer of the photoreceptive layer should have a ten-point average roughness Rz of 0.10 to 0.30 μm as defined in JIS-B-0601 (1994), and that the ten-point average roughness Rz and the average spacing Sm of the irregularities (bumps and dips) should satisfy the relationship Rz×Sm/2≤10.

If the ten-point average roughness Rz is less than 0.10 μm, the adhesion to the underlying layer may be insufficient due to too low silica content and the like. If the ten-point average roughness Rz exceeds 0.30 μm, silica aggregates are often present, which may cause variations in adhesion to the underlying layer and a decrease in dispersion stability of the coating liquid itself.

The ten-point average roughness Rz is preferably 0.15 to 0.30 μm, and more preferably 0.15 to 0.28 μm.

If Rz×Sm/2 exceeds 10, the contribution to adhesion may decrease.

The lower limit of Rz×Sm/2 is on the order of 2.5 to ensure adhesion; and the preferred Rz×Sm/2 is 3.0 to 5.0, and more preferably 2.5 to 3.5.

How to measure ten-point surface roughness (unevenness) Rz and average spacing Sm of the irregularities (surface asperities) will be described in Examples.

### Content of Silica Particles

The silica particles are contained at a ratio of 7 to 20 mass % based on a total solid content in the surface layer.

If the content of the silica particles is less than 7 mass % of the total solid content in the surface layer, adhesion and print resistance may become insufficient. If the silica particle content exceeds 20 mass % of the total solid content in the surface layer, a risk on agglomerate formation may increase, and problems may occur such as a crack in a blade caused by agglomerates if the coating liquid is used after long-term storage.

The content of the silica particles is preferably 7 to 15 mass %, and more preferably 7 to 12 mass %.

### Contact Angle of Surface of Photoreceptive Layer to Pure Water

The inventors of the present invention have confirmed that adhesion properties of the photoreceptive layer are increased by using any of the following resins in the photoreceptive layer coating liquid to which the silica particles have been added: a siloxane skeleton-type resin that reduces surface tension; a fluorinated resin; and a binder resin into which a substituent or the like is incorporated. This is presumably because wettability of the charge transporting layer coating liquid to the charge generating layer improves in the laminated photoreceptive layer.

The inventors of the present invention have confirmed that by reducing surface tension of the photoreceptive layer coating liquid, a contact angle of the photoreceptive layer surface increases, and lubricity improves. Although it is good that adhesion is improved, if an initial contact angle to pure water is made too high in the photoreceptor according to the present disclosure, repeated electrical fatigue will cause a difference in lubrication between an image forming area at the center of the photoreceptor and non-image forming areas at edges of the photoreceptor, making it easier for problems to occur such as blade curling (blade wrinkles) at the edges; and it has been confirmed that by adjusting the contact angle to approximately 85 to 94°, the blade curling can be prevented; and stable functionality can be developed over the long term. If the contact angle of the surface of the surface layer of the photoreceptive layer to pure water is made too low, a friction coefficient against the blade may increase due to an increase of adhered materials, such as discharge products, on the entire photoreceptor; and blade turn-up (blade warping) may occur even within the image forming area.

Thus, the photoreceptor according to the present disclosure has the surface of the surface layer of the photoreceptive layer with a contact angle of 85 to 94° to pure water. How to measure a contact angle to pure water will be specifically described in Examples.

### Creep Value C of Photoreceptive Layer

It is desirable that the surface layer of the photoreceptor according to the present disclosure should have a creep value C of 4.0% or higher, as measured by applying a maximum indentation load of 30 mN for 5 seconds using a Vickers square-based diamond indenter with an opposing angle of 136° where the photoreceptive layer is in an environment where the temperature is 25° C. and the relative humidity is 50%.

When the silica particles are introduced into the photoreceptive layer, there are tendencies such that flexibility of the photoreceptive layer decreases, and a creep value C decreases. If the creep value C of the surface of the photoreceptive layer is less than 4.0%, the surface tends to become vulnerable to external mechanical fatigue.

The upper limit of the creep value C is of the order of 5.0%, and the preferred creep value Cis from 4.0 to 4.6%.

How to measure creep values C will be specifically described in Examples.

### Binder Resin

The binder resin contained in the surface layer of the photoreceptive layer of the photoreceptor according to the present disclosure is a polycarbonate resin (also known as a “copolymerized polycarbonate resin”) represented by general formula (I) shown in FIG. 6, the binder resin comprising structural units (A) and (B):

wherein R11, R12, R21, and R22 are identically or independently a hydrogen atom, an alkyl group having 1 to 3 carbon atoms, or a fluoroalkyl group having 1 to 3 carbon atoms; X is a phenylene group, a biphenylene group, a naphthylene group, an alkylene group having 1 to 3 carbon atoms, or a cycloalkylene group having 3 to 6 carbon atoms; and m and n are exponents that meet the following relationship: 0.3≤m/(n+m)≤0.55.

Substituents and exponents in general formula (I) will be described.

Examples of the alkyl group having 1 to 3 carbon atoms denoted as the substituents R11, R12, R21, and R22 include methyl, ethyl, n-propyl, and isopropyl.

Examples of the fluoroalkyl group having 1 to 3 carbon atoms denoted as the substituents R11, R12, R21, and R22 include fluoromethyl, difluoromethyl, and trifluoromethyl.

Examples of the alkylene group having 1 to 3 carbon atoms denoted as the substituent X include methylene, ethylene, n-propylene, and isopropylene.

Examples of the cycloalkylene group having 3 to 6 carbon atoms denoted as the substituent X include cyclopropylene, isobutylene, isopentylene, and cyclohexylene.

If m/(n+m) is less than 0.3, print resistance and electrical fatigue resistance characteristics may be insufficient, whereas if m/(n+m) is more than 0.55, there may be a problem with solubility, possibly leading to poor productivity.

The desired relationship between m and n is 0.35≤m/(n+m)≤0.50.

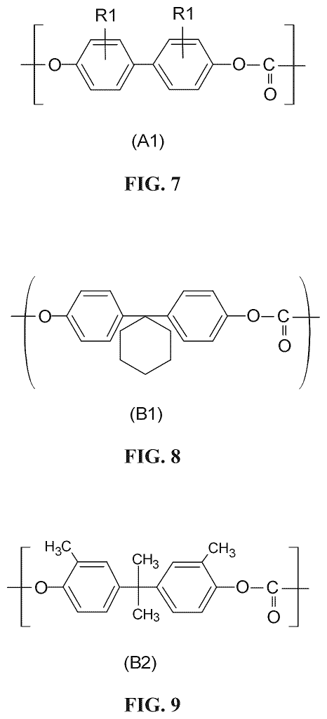

In the photoreceptor according to the present disclosure, it is desirable that structural unit (A) of a polycarbonate resin should be structural unit (A1) represented by a formula shown in FIG. 7:

wherein R1 is a hydrogen atom, an alkyl group having 1 or 2 carbon atoms, or a fluoroalkyl group having 1 or 2 carbon atoms; and
it is desirable that a mass Bw and a mass Hw of a low molecular weight component having a molecular weight of 1,000 or less in the binder resin in the surface layer of the photoreceptive layer should satisfy the following relationship: 38.2≤Hw/(Hw+Bw)×100≤43.0. The low molecular weight component having 1,000 or less molecular weight means component(s) other than the binder resin in the photoreceptive layer (excluding the silica particles, which are made of an inorganic material); and in a case where the photoreceptive layer is a laminated photoreceptive layer, which is a preferred embodiment of the photoreceptor according to the present disclosure, the low molecular weight component means a charge transporting material.

The inventors of the present invention have confirmed that by introducing structural unit (A) into the polycarbonate resin, Vickers hardness of the photoreceptive layer is improved, and mechanical strength of the photoreceptive layer is improved, and have also confirmed that by making substituents on aromatic rings of structural unit (A) the same, as seen in structural unit (A1), the mechanical strength of the photoreceptive layer is further improved.

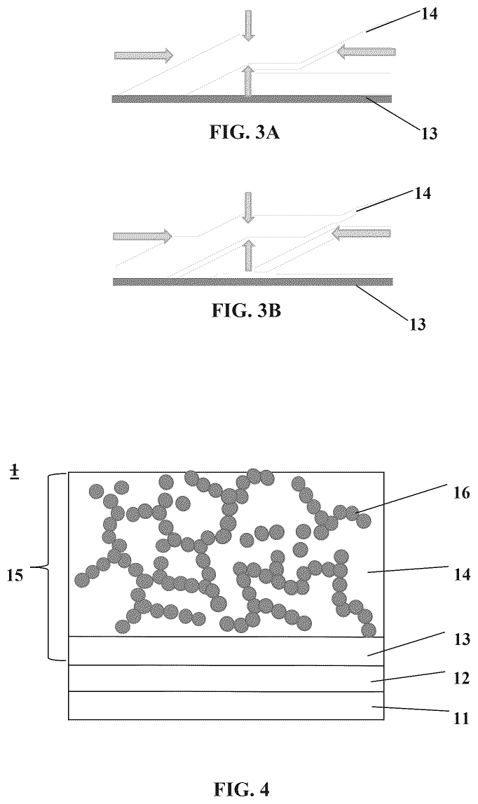

If the relationship Hw/(Hw+Bw)×100 between the mass Bw and the mass Hw of the low molecular weight component with a molecular weight of 1,000 or less in the binder resin is less than 38.2, there are tendencies such that adhesiveness of the charge generating layer may become insufficient, and charge injection from the charge generating layer may become poor. If Hw/(Hw+Bw)×100 exceeds 43.0, print resistance may become insufficient, and the advantages of the binder resin specified in the present disclosure may not be fully demonstrated. This is presumably because, during the formation of the photoreceptive layer by coating, the photoreceptive layer experiences large thermal shrinkage during drying (see FIG. 3A), resulting in large internal stress (see FIG. 3B).

More preferably, 39.0≤Hw/(Hw+Bw)×100≤43.0.

In the photoreceptor according to the present disclosure, it is desirable that structural unit (B) of a polycarbonate resin should be structural unit (B1) represented by the formula shown in FIG. 8 or structural unit (B2) represented by the formula shown in FIG. 9.

The inventors of the present invention have confirmed that the introduction of structural unit (B1) into structural unit (B) of the polycarbonate resin can reduce damage to the surface layer of the photoreceptive layer, which is caused by mechanical fatigue.

The inventors of the present invention have confirmed that the introduction of structural unit (B2) into structural unit (B) of the polycarbonate resin can improve the resistance of the surface of the photoreceptive layer against electrical fatigue.

Polycarbonate resins are resistant to mechanical fatigue, and a photoreceptor surface made of such a polycarbonate resin is difficult to be refreshed; however, there are tendencies such that surface lubricity decreases in an image forming area, and imbalance in surface properties occurs between the image forming area and non-image forming areas. Therefore, the introduction of structural unit (B2) can suppress the reduction of lubricity in the image forming area. Compared to structural unit (B1), structural unit (B2) has less mechanical strength of the photoreceptive layer; however, structural unit (B2) is more resistant to electrical fatigue, such as charging degradation, and can reduce friction with peripheral components, thereby reducing wear of a photoreceptor.

In the photoreceptor having the polycarbonate resin with the above-described structural units, it is desirable that each of the substituents R11 and R12 of structural unit (A) should be a hydrogen atom; structural unit (B) should be structural unit (B2); and the mass Bw and the mass Hw of the low molecular weight component with a molecular weight of 1,000 or less in the binder resin in the surface layer of the photoreceptive layer should meet the following relationship: 34≤Hw/(Hw+Bw)×100≤41.

If the relationship Hw/(Hw+Bw)×100 between the mass Bw and the mass Hw of the low molecular weight component with a molecular weight of 1,000 or less in the binder resin is less than 34, there are tendencies such that adhesion to the charge generating layer is insufficient; and charge injection from the charge generating layer is poor. If Hw/(Hw+Bw)×100 exceeds 43, there is a tendency such that resistance to charging fatigue deteriorates due to the reduced binder component in the photoreceptive layer.

Therefore, if the relationship 34≤Hw/(Hw+Bw)×100≤41 is satisfied, the photoreceptor has good characteristics.

More preferably, 35.0≤Hw/(Hw+Bw)×100≤38.5.

In general formula (I) of the polycarbonate resin, it is desirable that R11 and R12 should be the same substituent, R21 and R22 should be the same substituent, and either R11 or R21 should be a hydrogen atom.

The inventors of the present invention have confirmed that if a substituent paired with structural unit (A) and a substituent paired with structural unit (B) of the polycarbonate resin are the same, mechanical strength, such as Vickers hardness, of the photoreceptive layer increases.

It is desirable that the polycarbonate resin of the binder resin of the photoreceptor according to the present disclosure should have chain end groups, each of the chain end groups being formed of a monovalent aromatic group—in other words, each of chain ends of the polycarbonate resin is sealed desirably by a monovalent aromatic group. The chain end groups of the polycarbonate resin have a function of improving lubricity of the surface of the photoreceptive layer.

The chain end groups each may be a monovalent fluorine-containing aliphatic group. In this case, even if the surface of the surface layer of the photoreceptor is scraped (peeled), lubricity of the surface of the photoreceptive layer can be controlled by existing on the surface a certain amount of the fluorine-containing aliphatic groups as the chain end groups, which are incorporated in the polycarbonate resin, thereby suppressing blade turn-up and the like.

Examples of the monovalent aromatic group as the chain end group include: p-tert-butyl-phenonyl, p-phenylphenonyl, and p-cumylphenonyl.

Examples of the monovalent fluorine-containing aliphatic group as the chain end group include 2,2-difluoro-2-(perfluorohexyloxy) ethoxy and the following F1 to F4.

Among these chain end groups, p-tert-butyl-phenonyl is preferred because the introduction of a fluorine-containing aliphatic group may result in an excessively high contact angle of the photoreceptive layer surface to pure water.

By selecting the chain end group, it becomes possible to adjust the lubricity of the surface of the photoreceptor; and the above chain end groups are preferred from the viewpoint of improving electrical properties and abrasion resistance.

The polycarbonate resin with a specific structure contained in the photoreceptive layer of the photoreceptor according to the present disclosure can be synthesized, for example, by the method described in Japanese Patent No. 6893205.

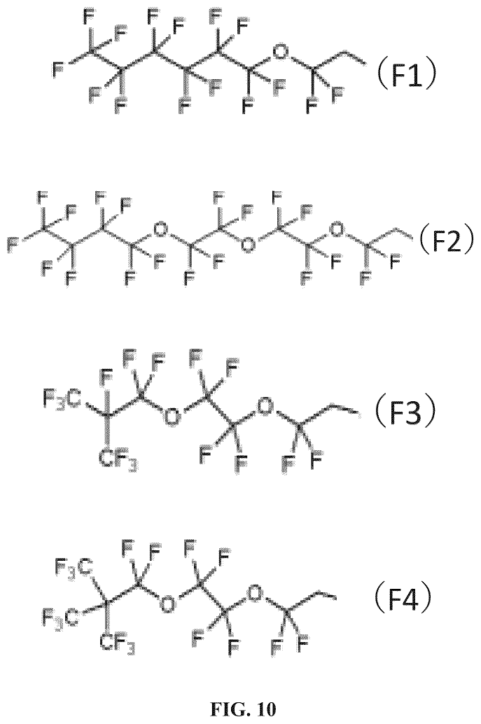

The above chain end groups are derived from an end sealant used during resin synthesis. Examples of the end sealant include: monovalent carboxylic acids and their derivatives and monovalent phenols; and more specifically, examples of the end sealant include: p-tert-butyl-phenol, p-phenylphenol, p-cumylphenol, 2,2-difluoro-2-(perfluorohexyloxy) ethanol, and fluorine-containing alcohols shown as (F1) to (F4) in FIG. 10.

Polycarbonate resins having a repeating unit represented by general formula (I) will be listed below; however, the present invention is not limited to these resins; and two or more of these resins can be used in combination.

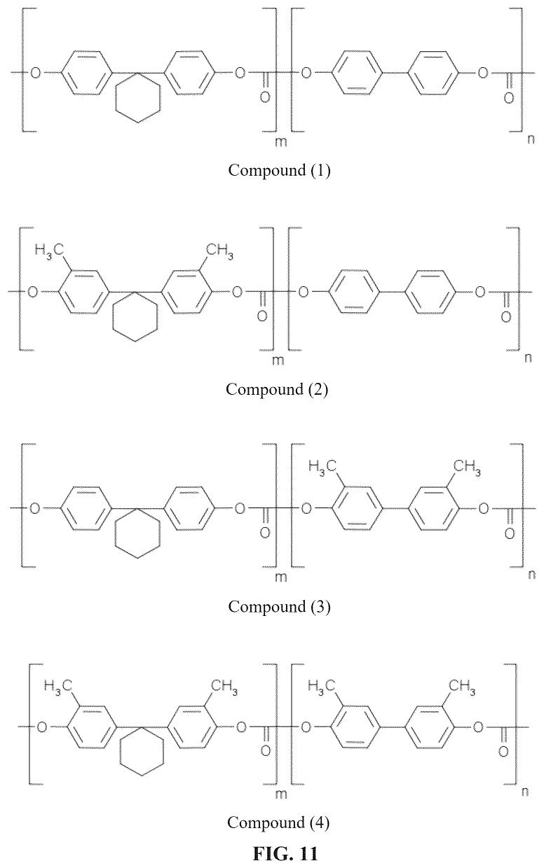

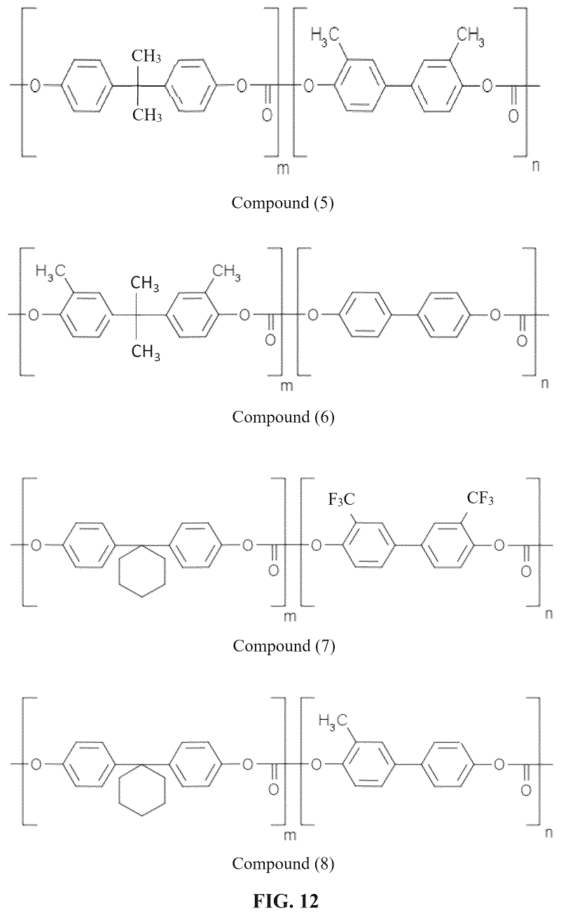

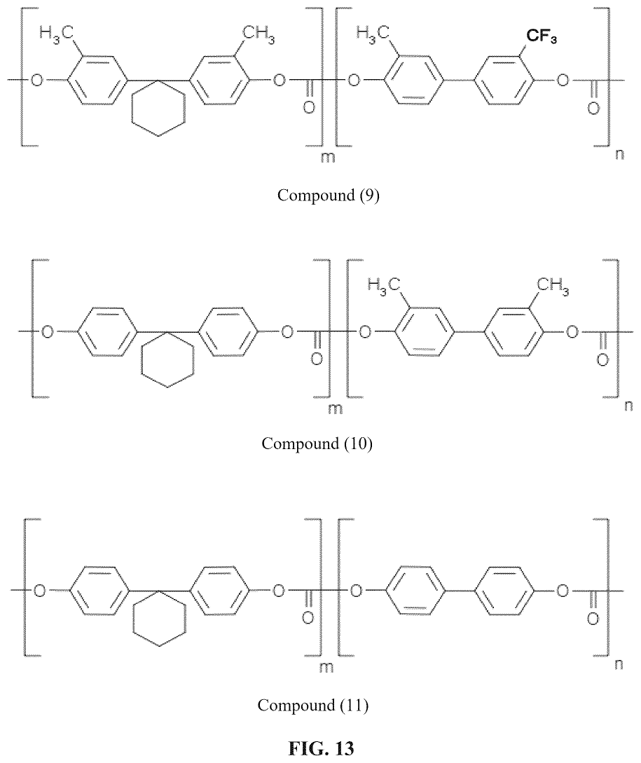

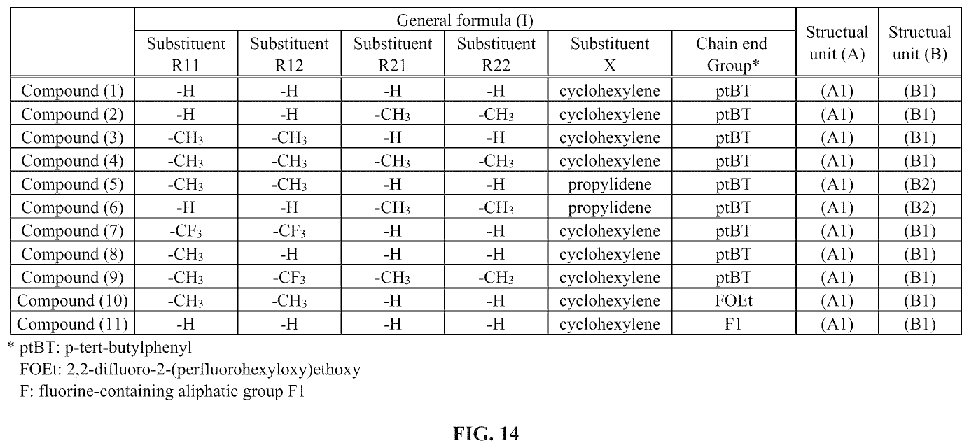

FIGS. 11 to 13 and 14 exemplify the substituents and the chain end groups of compounds (1) to (11) of the polycarbonate resins.

### Viscosity Average Molecular Weight of Polycarbonate Resin

The viscosity average molecular weight of the polycarbonate resin is desirably on the order of 45,000 to 65,000.

If the viscosity average molecular weight is less than 45,000, the print resistance may be insufficient, while if the viscosity average molecular weight exceeds 65,000, the viscosity of the coating liquid may become too high, possibly increasing a risk of occurrence of coating defects during coating.

The viscosity average molecular weight of the polycarbonate resin is desirably on the order of 50,000 to 62,000.

### (1) Electrophotographic Photoreceptor

The photoreceptor according to the present disclosure has at least the photoreceptive layer, which comprises one or more layers, on the conductive base.

The photoreceptive layer is, for example, either a laminated photoreceptive layer formed by laminating a charge generating layer containing a charge generating substance and a charge transporting layer containing a charge transporting substance in this order or a single-layer photoreceptive layer containing a charge generating substance and a charge transporting substance.

In a single-layer photoreceptor having the single-layer photoreceptive layer, the charge generating substance is distributed evenly in the photoreceptive layer; therefore, the single-layer photoreceptor is longer in electron transfer distance (electron travel distance) than the laminated photoreceptor having the laminated photoreceptive layer and thus is easily affected by a trapping substance present in the photoreceptive layer. If a photoreceptive layer contains silica particles as in the photoreceptor according to the present disclosure, the silica particles become trap(s); therefore, the laminated photoreceptor is preferable from the viewpoint of electrical characteristics.

In the following, the photoreceptor according to the present disclosure having the laminated photoreceptive layer will be described with reference to the drawings; however, the present invention is not limited to the following descriptions.

FIG. 4 is a diagrammatic cross-sectional view showing a configuration of a main part of a photoreceptor 1 according to the present disclosure.

The laminated photoreceptor 1 has an undercoat layer 12 and a photoreceptive layer 15 in this order on a conductive base 11, the photoreceptive layer 15 comprising, in the following order stacked on the undercoat layer 12: a charge generating layer 13 containing a charge generating substance; and a charge transporting layer 14 containing a charge transporting substance and silica particles 16.

### Conductive Base 11

The conductive base has a function as an electrode of the photoreceptor and a function as a supporting member; and constituent materials for the conductive base should not be particularly limited as long as the materials are used in the art.

Specifically, examples of the constituent materials may include: metallic materials such as aluminum, aluminum alloys, copper, zinc, stainless steel, and titanium; polymer materials such as polyethylene terephthalate, nylon, and polystyrene that have a surface treated with metallic foil lamination, metallic vapor deposition, or vapor deposition or coating of a layer of a conductive compound such as a conductive polymer, tin oxide, or indium oxide; hard paper; and glass. Among these materials, aluminum is preferable from the viewpoint of ease of processing; and the aluminum alloys are particularly preferable, such as JIS3003 series, JIS5000 series, and JIS6000 series.

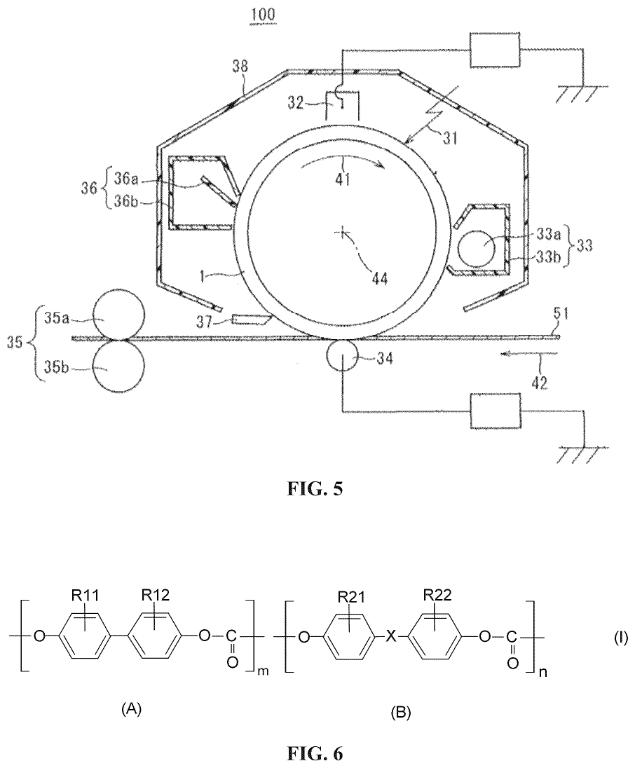

A shape of the conductive base is not limited to a cylindrical shape (drum shape) as shown in FIG. 5, and may be a sheet shape, a columnar shape, an endless belt shape, or the like.

A surface of the conductive base may be treated, as necessary, with anodic oxidation coating, surface treatment with chemicals or hot water, coloring, or irregular reflection treatment such as surface roughening, without affecting image quality, for the purpose of preventing interference fringes, which could be caused by laser beams.

### Undercoat Layer 11

The photoreceptor according to the present disclosure desirably comprises the undercoat layer (also called an “intermediate layer”) disposed between the conductive base and the photoreceptive layer.

The undercoat layer generally coats irregularities on the surface of the conductive base to even out the irregularities to increase film formability of the laminated photoreceptive layer and suppresses peeling-off of the photoreceptive layer from the conductive base to improve adhesiveness between the conductive base and the photoreceptive layer. Specifically, it is possible to prevent injection of charges from the conductive base to the photoreceptive layer, to prevent reduction of chargeability of the photoreceptive layer, and to prevent image fogging (a so-called black spot).

The undercoat layer can be formed by, for example, dissolving a binder resin in an appropriate solvent to prepare an undercoat layer coating liquid, applying this coating liquid on the surface of the conductive base, and removing the organic solvent by drying.

Examples of the binder resin may include: acetal resins, polyamide resins, polyurethane resins, polyester resins, acrylic resins, epoxy resins, phenol resins, melamine resins, and urethane resins. The binder resin is required to have characteristics, such as not to develop dissolution in or swelling to a solvent used for forming a photoreceptive layer on the undercoat layer, to have excellent adhesiveness to the conductive base, and to have flexibility. Accordingly, among the binder resins listed above, the polyamide resins are preferable; and of the polyamide resins, alcohol-soluble nylon resins and piperazine-based compound-containing polyamide resins are particularly preferable.

Examples of the alcohol-soluble nylon resins may include: homopolymerized or copolymerized nylons, such as 6-nylon, 66-nylon, 610-nylon, 11-nylon, and 12-nylon; and chemically-modified nylon resins, such as N-alkoxy methyl-modified nylon.

A curing agent may be used that crosslinks the binder resins so as to form a curing film. As the curing agent, blocked isocyanate is desirable from the viewpoint of preservation stability and electrical characteristics of the coating liquid.

Examples of the solvent may include: water; lower alcohols such as methanol, ethanol, n-propyl alcohol, isopropyl alcohol, n-butanol, 2-butanol, and isobutanol; ketones such as acetone, cyclohexanone, and 2-butanone; ethers such as tetrahydrofuran, dioxane, ethylene glycol, and diethyl ether; and halogenated hydrocarbons such as dichloromethane and dichloroethane. These solvents may be appropriately selected in consideration of solubility of the binder resin and surface smoothness of the undercoat layer; and the solvents may be used independently, or two or more kinds may be used in combination.

Among these solvents, non-halogen organic solvents, for example, may be suitably used out of consideration for the global environment.

The undercoat layer coating liquid may contain metal oxide particles. The metal oxide particles can easily modulate a volume resistance value of the undercoat layer and can further suppress injection of charges to the charge generating layer and also can maintain the electric properties of the photoreceptor in a variety of environments.

Examples of materials for the metal oxide particles may include titanium oxide, aluminum oxide, aluminum hydroxide, and tin oxide.

The ratio (A/B) between a total mass A of the binder resin and the metal oxide particles and a mass B of the solvent in the undercoat layer coating liquid should be preferably of the order of 1/99 to 30/70 and particularly preferably of the order of 2/98 to 40/60.

The ratio (C/D) between a mass C of the binder resin and a mass D of the metal oxide particles should be preferably of the order of 1/99 to 90/10 and particularly preferably of the order of 5/95 to 70/30.

As a method for applying the undercoat layer coating liquid, an optimum method may be appropriately selected in consideration of physical properties and productivity of the coating liquid; and examples of the method may include: a spray method, a bar coating method, a roll coating method, a blade method, a ring method, and an immersion coating method. Among these methods, in the immersion coating method, a conductive base is immersed in a coating bath filled with a coating liquid and is then raised at a constant speed or a continuously changing speed to form a layer (film) on a surface of the conductive base. This immersion coating method is relatively simple and excellent in productivity and cost, and therefore can be suitably used for manufacturing the photoreceptor. An apparatus used in the immersion coating method may be equipped with a coat liquid disperser typified by an ultrasonic wave generator for the purpose of stabilizing dispersibility of the coating liquid.

The solvent in the coating film may be removed by natural drying, but may be forcibly removed by heating.

A temperature in such a drying step should not be particularly limited as long as the solvent used can be removed; however, the temperature is suitably on the order of 50 to 140° C., and particularly preferably on the order of 80 to 130° C.

If the drying temperature is lower than 50° C., a drying time may be prolonged, and the solvent may not sufficiently evaporate and may remain in the photoreceptive layer in some cases. If the drying temperature is higher than about 140° C., the electrical properties of the photoreceptor during repeated use become poor, and an image obtained may deteriorate. Such temperature conditions are common in formation of not only the undercoat layer but also a layer, such as a photoreceptive layer to be described later, and in other treatments.

A thickness of the undercoat layer is not particularly limited, but should be preferably from 0.01 to 20 μm, and more preferably from 0.05 to 10 μm.

If the thickness of the undercoat layer is less than 0.01 μm, the layer may not be sufficiently effective on blocking injection of charges from the conductive base and preventing interference fringes caused by light scattering. If the thickness of the undercoat layer is more than 20 μm, sensitivity may greatly change after repeated printing, and eventually image density may greatly change.

### Charge Generating Layer 15

The charge generating layer has a function of generating charges by absorbing irradiated light, such as a light beam (e.g., a semiconductor laser), emitted from a light emitting apparatus in an image-forming apparatus or the like, and contains a charge generating substance as a main ingredient and, as necessary, contains a binder resin and additives.

As the charge generating substance, a compound used in the art can be used; and specific examples thereof may include azo-based pigments, such as monoazo-based pigments, bisazo-based pigments, and trisazo-based pigments; indigo-based pigments, such as indigo and thioindigo; perylene-based pigments, such as perylene imide and perylene anhydride; polycyclic quinone-based pigments, such as anthraquinone and pyrene quinone; phthalocyanine-based pigments, such as metallic phthalocyanines including titanyl phthalocyanine and metal-free phthalocyanines; organic photoconductive materials, such as squarylium dyes, pyrylium salts, thiopyrylium salts, and triphenylmethane-based dyes; and inorganic photoconductive materials, such as selenium and amorphous silicon; and from which one having sensitivity in an exposure wavelength range can be appropriately selected to be used. These charge generating substances may be used alone or in combination of two or more types.

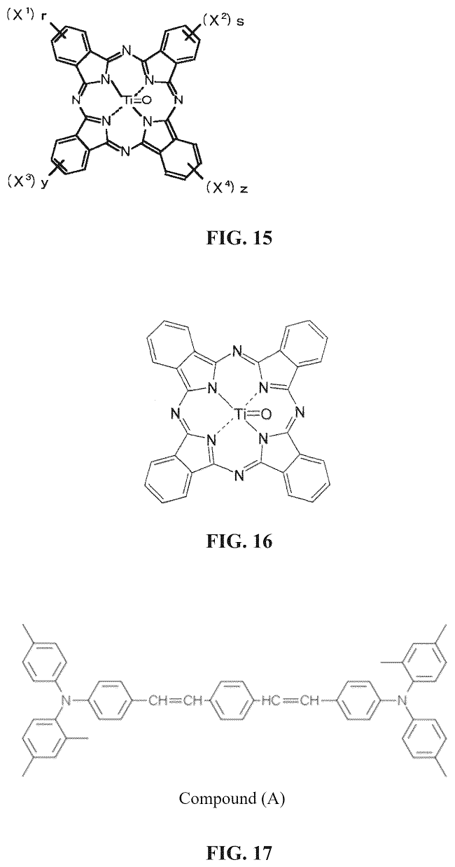

Among these charge generating substances, a titanyl phthalocyanine represented by general formula (A) shown in FIG. 15 may be preferably used:

wherein X¹, X², X³, and X⁴ are identically or independently a halogen atom, an alkyl group, or an alkoxy group; and r, s, y, and z are identically or independently an integer of 0 to 4. Titanyl phthalocyanine is a charge generating substance that has high charge generating efficiency and charge injection efficiency in an emission wavelength range (near-infrared light) of laser beams and LED light currently and commonly used, and can generate a large amount of charges by absorbing light, as well as efficiently inject the generated charges into a hole transporting substance without accumulating the charges thereinside.

The titanyl phthalocyanine represented by general formula (A) can be manufactured, for example, by any known manufacture methods, such as a method described in Moser, Frank H. and Arthur L. Thomas. Phthalocyanine Compounds. 1963. New York. Reinhold Publishing Corporation.

Among titanyl phthalocyanine compounds represented by general formula (A), for example, an unsubstituted titanyl phthalocyanine, in which r, s, y, and z are 0, can be obtained by heating and melting phthalonitrile and titanium tetrachloride or heating and reacting them in a suitable solvent, such as a-chloronaphthalene, to synthesize a dichlorotitanyl phthalocyanine, and then hydrolyzing the dichlorotitanyl phthalocyanine with a base or water.

Also, a titanyl phthalocyanine composition can be manufactured by heating and reacting isoindoline with titanium tetraalkoxide, such as tetrabutoxytitanium, in a suitable solvent, such as N-methylpyrrolidone.

Examples of the method for forming the charge generating layer may include: a method for vacuum-depositing the charge generating substance on the conductive base; and a method for applying on the conductive base a charge generating layer coating liquid obtained by dispersing the charge generating substance into a solvent. Of these examples, the following method is preferable: the method for applying on the conductive base a charge generating layer coating liquid obtained by dispersing the charge generating substance by a traditionally known method into a binder resin solution obtained by mixing a binder resin with a solvent. This method will be described below.

The binder resin is not particularly limited and can employ any resin known in the art; and examples of the binder resin may include: resins, such as polyester, polystyrene, polyurethane, phenol resins, alkyd resins, melamine resins, epoxy resins, silicone resins, acrylic resins, methacrylic resins, polycarbonate, polyarylate, polyphenoxy, polyvinyl butyral, and polyvinyl formal; and copolymer resins containing two or more of repeated units constituting these resins.

Examples of the copolymer resins may include: insulative resins, such as vinyl chloride-vinyl acetate copolymer resins, vinyl chloride-vinyl acetate-maleic anhydride copolymer resins, and acrylonitrile-styrene copolymer resins. These resins may be used independently, or two or more kinds may be used in combination.

Examples of the solvent may include: halogenated hydrocarbons such as dichloromethane and dichloroethane; ketones such as acetone, methylethylketone, and cyclohexanone; esters such as ethyl acetate and butyl acetate; ethers such as tetrahydrofuran (THF) and dioxane; alkyl ethers of ethylene glycol such as 1,2-dimethoxy ethane; aromatic hydrocarbons such as benzene, toluene, and xylene; and polar aprotic solvents such as N,N-dimethylformamide and N,N-dimethylacetamide. These solvents may be used independently, or two or more kinds may be used in combination.

As for a blending ratio of the charge generating substance to the binder resin, the ratio of the charge generating substance should be desirably in a range of 10 to 99 mass %. If the ratio of the charge generating substance is lower than 10 mass %, sensitivity may decrease. If the ratio of the charge generating substance is higher than 99 mass %, not only film strength of the charge generating layer may decrease, but also dispersibility of the charge generating substance may decrease, leading to an increase of large rough particles, thus reducing surface charges of an area other than an area to be deleted by exposure and generating many image defects, especially image fogs—which are also known as black spots—that are formed when toner adheres to white background and becomes minute black dots.

Before the charge generating substance is dispersed into a binder resin solution, the charge generating substance may be ground with a grinder in advance. Examples of the grinder used for the grinding may include: a ball mill, a sand mill, an attritor, a vibration mill, and a sonic disperser.

Examples of the disperser used for dispersing the charge generating substance into the binder resin solution may include: a paint shaker, a ball mill, and a sand mill. As for conditions for this dispersion, it may be necessary to select appropriate conditions for preventing contamination by wear or the like of parts constituting a container or the disperser to be used.

The method for applying the charge generating layer coating liquid may be the same as the methods for applying the undercoat layer coating liquid, and the immersion coating method is particularly preferable.

A thickness of the charge generating layer is not particularly limited, but should be preferably from 0.05 to 5 μm; and more preferably from 0.1 to 1 μm.

If the thickness of the charge generating layer is less than 0.05 μm, light absorption efficiency may decrease, possibly lowering sensitivity of the photoreceptor. If the thickness of the charge generating layer is more than 5 μm, a charge transfer process inside the charge generating layer comes to a rate-limiting phase in a process of erasing the charges on a surface of the laminated photoreceptive layer, possibly lowering sensitivity of the photoreceptor.

### Charge Transporting Layer 16

The charge transporting layer has a function of receiving charges generated in the charge generating substance and transporting the charges to a surface of the photoreceptor, and contains a charge transporting substance, a binder resin, and silica particles, and as necessary, additives. In a photoreceptor shown in FIG. 4, a charge transporting layer is indicated as a surface layer of a photoreceptive layer.

As the charge transporting substance, a compound used in the art can be used. Examples of the compound (used for the charge transporting substance) include: carbazole derivatives, pyrene derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives, butadiene derivatives, enamine derivatives, benzidine derivatives, polymers having a group derived from these compounds in a main chain or a side chain (such as poly-N-vinyl carbazole, poly-1-vinyl pyrene, an ethylcarbazole-formaldehyde resin, triphenyl methane polymer, and poly-9-vinyl anthracene), and polysilane. These hole transporting substances may be used alone or in combination of two or more types.

The charge transporting layer is formed desirably as follows: The charge transporting substance and the silica particles are dispersed by a traditionally-known method in a binder resin solution obtained by mixing a binder resin with a solvent; and a charge transporting layer coating liquid is applied on the charge generating layer. This method will be described below.

The charge transporting layer may contain additives, such as a plasticizer and a leveling agent, as necessary, to improve film formability, flexibility, and surface smoothness. Examples of the plasticizer may include: dibasic acid esters, such as phthalic acid esters; fatty acid esters; phosphoric acid esters; chlorinated paraffins; and epoxy-type plasticizers. Examples of the leveling agent may include silicon-based leveling agents.

Examples of the solvent may include: aromatic hydrocarbons, such as benzene, toluene, xylene, and monochlorobenzene; halogenated hydrocarbons, such as dichloromethane and dichloroethane; ethers, such as THE, dioxane, and dimethoxy methyl ether; and polar aprotic solvents, such as N,N-dimethylformamide. Also, any of the following solvents may be added as necessary: alcohols, acetonitrile, and methylethylketone. Among these solvents, non-halogen organic solvents are suitable to be used out of consideration for the global environment. These solvents may be used alone or in combination of two or more types.

As for a blending ratio of the charge transporting substance to the binder resin, the ratio of the charge transporting substance should be desirably in a range of 30 to 43 mass %. If the ratio of the charge transporting substance is lower than 30 mass %, sensitivity characteristics may become deteriorated, and resistance to repeated electric fatigue may decrease. If the ratio of the charge transporting substance is higher than 43 mass %, print resistance may become weak, possibly shortening the life of the photoreceptor. If the charge transporting layer is placed as a surface layer of the photoreceptive layer, a content of the silica particles to a total solid content in the photoreceptive layer is as described above.

The charge transporting layer is formed, in a similar way to how the charge generating layer is formed as described above, for example, by dissolving or dispersing the following substances in an appropriate solvent to prepare a charge transporting layer coating liquid: a charge transporting substance and a binder resin and, if necessary, the above-mentioned additives, and by applying this coating liquid on the charge generating layer by a spray method, a bar coating method, a roll coating method, a blade method, a ring method, an immersion coating method, or the like. Of these application methods, the immersion coating method is particularly suitable for the formation of the charge transporting layer because, as described above, this method excels in many ways.

A thickness of the charge transporting layer is not particularly limited, but should be preferably 5 μm or more to 50 μm or less, and more preferably 10 μm or more to 40 μm or less. If the thickness of the charge transporting layer is less than 5 μm, charge retention ability of the photoreceptor surface may decrease. If the thickness of the charge transporting layer is more than 50 μm, resolution of the photoreceptor may decrease.

### (2) Image-Forming Apparatus 100

An image-forming apparatus according to the present disclosure is characterized by comprising at least: the photoreceptor according to the present disclosure; an electrifier for electrifying the photoreceptor; an exposer for exposing the electrified photoreceptor to form an electrostatic latent image; a developer for developing the electrostatic latent image to form (visualize) a toner image; and a transferer for transferring the toner image onto a recording medium.

The image-forming apparatus according to the present disclosure may also comprise any of structures selected from: a fuser for fusing the transferred toner image onto the recording medium to form an image; a cleaner for removing and recovering a toner remaining on the photoreceptor; and a charge eliminator for eliminating surface charges remaining on the photoreceptor.

The image-forming apparatus according to the present disclosure and operations thereof will be described below with reference to the drawings; however, the image-forming apparatus according to the present disclosure is not limited to the following descriptions.

FIG. 5 is a schematic side view showing a configuration of key components of an image-forming apparatus 100 according to the present disclosure.

The image-forming apparatus (laser printer) 100 shown in FIG. 5 is configured to comprise: a photoreceptor 1 according to the present disclosure (which is comparable to the illustration denoted as 1 in FIG. 4); an exposer (semiconductor laser) 31; an electrifier (electrifying device) 32; a developer (developing device) 33; a transferer (transfer electrifying device) 34; a conveyor belt (not shown); a fuser (fusing device) 35; and a cleaner (cleaning device) 36. Reference numeral 51 denotes a recording medium (recording paper or transfer paper).

The photoreceptor 1 is rotatably supported by a main body of the image-forming apparatus 100 and rotationally driven around a rotation axis line 44 in a direction of an arrow 41 by a driver (not shown in the drawings). The driver is configured to comprise, for example, an electric motor and a reduction gear and transmit its driving force to the conductive base constituting a core body of the photoreceptor 1, so that the photoreceptor 1 is rotationally driven at a predetermined peripheral velocity. The electrifier 32, the exposer 31, the developer 33, the transferer 34, and the cleaner 36 are arranged in this order along an outer peripheral surface of the photoreceptor 1 from an upstream side to a downstream side in the rotation direction of the photoreceptor 1 indicated by the arrow 41.

The electrifying device 32 is an electrifier that uniformly electrifies the outer peripheral surface of the photoreceptor 1 at a predetermined potential.

Examples of the electrifier include: a non-contact-type electrifier, such as a corona electrifier type, for example, an electrifying charger; and a contact-type electrifier, such as an electrifying roller or an electrifying brush.

The exposer 31 comprises a semiconductor laser as a light source and emits laser beam light output from the light source onto the surface of the photoreceptor 1 between the electrifying device 32 and the developing device 33, thereby irradiating the outer peripheral surface of the photoreceptor 1 with the light according to image information. The light beams repeatedly scan the outer peripheral surface of the photoreceptor 1 in a direction extending along the rotation axis line 44 of the photoreceptor 1 as a main scanning direction, and these light beams form images, so that electrostatic latent images are sequentially formed on the surface of the photoreceptor 1. That means, the presence or absence of laser beam irradiation causes differences in electrification amounts of the photoreceptor 1 uniformly electrified by the electrifying device 32 so as to form the electrostatic latent images.

The developing device 33 is a developer that develops, using a developing agent (toner), the electrostatic latent image formed on the surface of the photoreceptor 1 by light exposure, and is arranged facing the photoreceptor 1; and the developing device 33 comprises: a developing roller 33a for feeding the toner to the outer peripheral surface of the photoreceptor 1; and a casing 33b for supporting the developing roller 33a rotatably around a rotation axis line parallel to the rotation axis line 44 of the photoreceptor 1 and for accommodating the developing agent containing the toner in its own internal space.

The transfer electrifying device 34 is a transferer for transferring a toner image as a visible image formed on the outer peripheral surface of the photoreceptor 1 by development onto a transfer paper 51 that is a recording medium fed to between the photoreceptor 1 and the transfer electrifying device 34 from an arrow 42 direction by means of a conveyor (not shown in the drawings). The transfer electrifying device 34 is, for example, a contact-type transferer that comprises the electrifier and transfers a toner image onto the transfer paper 51 by applying a charge of the opposite polarity to the toner to the transfer paper 51.

The cleaning device 36 is a cleaner for removing and recovering (collecting) the toner remaining on the outer peripheral surface of the photoreceptor 1 after the transfer operation using the transfer electrifying device 34, and comprises: a cleaning blade 36a for peeling off (taking off) the toner remaining on the outer peripheral surface of the photoreceptor 1; and a recovery casing 36b for accommodating the toner peeled off by the cleaning blade 36a. The cleaning device 36 is disposed together with a charge eliminating lamp, which is not shown in the drawings.

The image-forming apparatus 100 has the fusing device 35 as a fuser for fusing the transferred image, the fusing device 35 being placed on the downstream side to where the transfer paper 51, which has passed between the photoreceptor 1 and the transfer electrifying device 34, is conveyed. The fusing device 35 comprises: a heat roller 35a having a heater (not illustrated); and a pressure roller 35b arranged opposite to the heat roller 35a and pressed by the heat roller 35a to form a contact portion.

The reference numeral 37 indicates a separator that separates the transfer paper from the photoreceptor, and the reference numeral 38 indicates a housing that accommodates each of the above-mentioned components in the image-forming apparatus.

The image-forming operations by the image-forming apparatus 100 are performed as follows. First, once the photoreceptor 1 is rotationally driven in the direction of the arrow 41 by the driver, the surface of the photoreceptor 1 is uniformly electrified (charged) at a predetermined positive potential by the electrifying device 32 provided upstream in the rotational direction of the photoreceptor 1 from a point of the image formation by light to be emitted from the exposer 31.

Subsequently, the exposer 31 emits light according to the image information toward the surface of the photoreceptor 1. In the photoreceptor 1, surface charges of a part irradiated with the light are removed by this exposure, causing a difference in surface potential between the part irradiated with the light and a part not irradiated with the light to form an electrostatic latent image.

The developer 33 disposed on the downstream side in the rotational direction of the photoreceptor 1 from a point of the image formation by the light emitted from the exposer 31 supplies a toner to the surface of the photoreceptor 1 on which the electrostatic latent image has been formed, and then the electrostatic latent image is developed to form a toner image.

A transfer paper 51 is fed to between the photoreceptor 1 and the transfer electrifying device 34 in synchronization with the exposure to the photoreceptor 1. A charge that is opposite in polarity to the toner is applied to the fed transfer paper 51 by the transfer electrifying device 34, so that the toner image formed on the surface of the photoreceptor 1 is transferred onto the transfer paper 51.

The transfer paper 51, to which the toner image has been transferred, is conveyed to the fusing device 35 by the conveyor and is heated and pressurized while passing through a contact portion between the heat roller 35a and the pressure roller 35b of the fusing device 35; and the toner image is fused to the transfer paper 51 to obtain a robust image. The transfer paper 51 on which the image has been formed in this way is discharged to the outside of the image-forming apparatus 100 by the conveyor.

The toner remaining on the surface of the photoreceptor 1 even after the transfer of the toner image by the transfer electrifying device 34 is peeled off from the surface of the photoreceptor 1 and recovered by the cleaning device 36. The charges on the surface of the photoreceptor 1 from which the toner has been removed in this way are removed by light from a charge eliminating lamp, and the electrostatic latent image on the surface of the photoreceptor 1 disappears. After that, the photoreceptor 1 is further rotationally driven, and a series of the operations starting from the electrification are repeated to continuously form images.

The above-described image-forming apparatus 100 is a monochrome image-forming apparatus (printer); however, this may also be, for example, an intermediate transfer-type color image-forming apparatus capable of forming color images. Specifically, this may be a so-called tandem-type full-color image-forming apparatus having a structure in which a plurality of electrophotographic photoreceptors are arranged side by side in a predetermined direction (for example, a horizontal direction H or an abbreviated horizontal direction H), each of which forms a toner image. The image-forming apparatus 100 may also be other color image-forming apparatuses, a copier, a multifunction peripheral, or a facsimile machine.

### EXAMPLES

Hereinafter, the present disclosure will be specifically described as Examples and Comparative Examples; however, these Examples do not limit the present invention as long as the Examples do not go beyond the essential contents of the present invention.

In the Examples and the Comparative Examples, physical properties of materials used and of photoreceptors prepared were measured by the following methods.

### (1) Number Average Primary Particle Diameter of Silica Particles

Using a scanning electron microscope (SEM; model: S-4800, manufactured by Hitachi High-Tech Corporation), silica particles are photographed at a magnification of 30,000 to 300,000 times, for example, 100,000 times; and any one hundred (100) silica particles photographed in an image obtained are observed as primary particles; and then an average value of particle diameter (long diameter) in the Feret direction is calculated by an image analysis, making it as a number average primary particle diameter (nm).

### (2) Ten-Point Average Roughness Rz of Surface of Surface Layer and Average Spacing Sm of Surface Irregularities of Surface Layer

With the use of a reference length of 0.8 mm, a cutoff wavelength of 0.8 mm, a measurement speed of 0.1 mm/sec, and a cutoff type Gaussian method, using a surface-roughness measuring device (model: Surfcom 1400D, manufactured by TOKYO SEIMITSU CO., LTD), ten-point surface roughness Rz (μm) and average spacing Sm (μm) of irregularities of a 4 mm-wide area at a center part of a charged area in an axial direction of the photoreceptor on an outermost surface layer (charge transporting layer) are measured. A ratio Sm/Rz is calculated from results thereby obtained.

Rz and Sm are respectively comparable to ten-point surface roughness Rz and average spacing Sm of irregularities defined in JIS-B-0601 (1994).

### (3) Contact Angle of Surface of Photoreceptive Layer to Pure Water

Using a contact angle measurer (model: CA-X, manufactured by Kyowa Interface Science Co., Ltd.) and pure water as a reagent, a contact angle (°) of the charge transporting layer surface is measured before and after an endurance test on photoreceptors.

### (4) Creep Value C of Photoreceptive Layer

Using a micro hardness measuring instrument (model: FISCHERSCOPE™ H100V, manufactured by FISCHER INSTRUMENTS K.K.), with the use of a Vickers square-based diamond indenter with an opposing angle of 136° in an environment where the temperature is 25° C. and the relative humidity is 50%, a creep value C (%) is measured by applying a maximum indentation load of 30 mN for 5 seconds.

A creep value C (%) is obtained by the following formula using an indentation depth h1 at a time of reaching a maximum indentation load of 30 mN and an indentation depth h2 at a time of maintaining at the maximum indentation load of 30 mN:

$$C ( \% ) = 100 \times ( h 2 - h 1 ) / h 1$$

### Example 1

### Formation of Undercoat Layer

3 parts by mass of titanium oxide (product name: TIPAQUE™ TTO-D-1, manufactured by ISHIHARA SANGYO KAISHA, LTD.) and 2 parts by mass of a copolymerized polyamide (nylon) (product name: Amilan™; grade: CM8000, manufactured by Toray Industries, Inc.) were added to 25 parts by mass of methyl alcohol and were then dispersed therein by a paint shaker for 8 hours to prepare 3 L of an undercoat layer coating liquid.

A bath was filled with the undercoat layer coating liquid obtained above; and an aluminum drum-shaped base having a diameter of 30 mm and a length of 255 mm as a conductive base 11 was immersed into the coating liquid and then was pulled up. A coating film (or simply a film) thereby obtained was dried naturally to form an undercoat layer 12 having a thickness of 1 μm on the conductive base 11.

### Formation of Charge Generating Layer

Titanyl phthalocyanine represented by the structural formula shown in FIG. 16 was prepared in advance, which was to be used as a charge generating substance.

29.2 g of diiminoisoindoline was mixed with 200 ml of sulfolane; and 17.0 g of titanium tetraisopropoxide was then added to the mixture; and the resulting mixture was allowed to react under nitrogen atmosphere at 140° C. for 2 hours. The reaction mixture thereby obtained was left to cool; and then a precipitate was filtered off, washed with chloroform and 2% aqueous hydrochloric acid solution in this order, further washed with water and methanol in this order, and then dried to obtain 25.5 g of blue-violet crystal.

As a result of chemical analysis of the crystal obtained, the crystal was confirmed to be titanyl phthalocyanine represented by the structural formula shown in FIG. 16 (88.5% yield).

1 part by mass of the obtained titanyl phthalocyanine and 1 part by mass of a butyral resin (product name: S-LEC BM-2, manufactured by SEKISUI CHEMICAL CO., LTD.) were added to 98 parts by mass of methylethylketone and were dispersed therein by a paint shaker for 2 hours to prepare 3 L of a charge generating layer coating liquid.

The thereby-obtained charge generating layer coating liquid was applied onto the undercoat layer 12 in the same immersion technique as in the formation of the undercoat layer; and a coating film thereby obtained was dried naturally to form a charge generating layer 13 having a thickness of 0.3 μm.

### Formation of Charge Transporting Layer

10 g of silica particles (product name: AEROSIL™ R972, manufactured by NIPPON AEROSIL CO., LTD.; number average primary particle diameter of 16 nm; subjected to a dimethyldichlorosilane surface treatment) were suspended in 56.7 g of tetrahydrofuran and stirred for 5 minutes using a stirrer (product name: Damatorisystem, manufactured by YOSHIDA KIKAI CO., LTD.).

The suspension obtained was poured into a wide-mouth bottle container with a capacity of 500 mL; and 33.3 g of tetrahydrofuran was added thereto; and then the mixture was stirred for 5 hours. To the mixture, the following materials were added and mixed and further stirred for 10 hours:
37.5 g of a stilbene derivative (compound (A)) represented by the structural formula shown in FIG. 17 as a charge transporting substance;
52.5 g of a polycarbonate resin (compound (3), represented by general formula (I) in which exponent m=3, exponent n=7, chain end group: p-tert-butylphenyl, 61230 of viscosity average molecular weight) as a binder resin;
0.011 g of silicone oil (product name: KF96, manufactured by Shin-Etsu Chemical Co., Ltd.); and
386.2 g of tetrahydrofuran.

The mixture obtained was subjected to 10-pass dispersion using a wet media-less atomizer (product name: Nanovater L-AS, manufactured by YOSHIDA KIKAI CO., LTD.) and then was subjected to a defoaming treatment for 3 minute by a rotation and revolution type mixer (product name: non-vacuum type ARE-310, manufactured by THINKY CORPORATION), thereby obtaining 536.0 g of a charge transporting layer coating liquid (93.0% yield)

The thereby-obtained charge transporting layer coating liquid was applied onto the charge generating layer 13 in the same immersion technique as in the formation of the undercoat layer; and a coating film thereby obtained was dried at 110° C. for 1.0 hour and then was dried at 130° C. for 1 hour to be a surface layer (charge transporting layer) 14 having a thickness of 35 μm, obtaining a photoreceptor of Example 1, which is schematically shown in FIG. 4. The above-mentioned compound (A) (stilbene compound) was prepared in advance in accordance with the method described in Japanese Patent No. 3272257.

### Example 2

In the preparation of a coating liquid for forming a charge transporting layer, a photoreceptor of Example 2 was prepared in the same way as in Example 1 except the following condition:
compound (3) (represented by general formula (I) in which exponent m=4, exponent n=6, chain end group: p-tert-butylphenyl, 61156 of viscosity average molecular weight) was used as a polycarbonate resin,
   thereby obtaining 529.4 g of a charge transporting layer coating liquid (91.8% yield).

### Example 3

In the preparation of a coating liquid for forming a charge transporting layer, a photoreceptor of Example 3 was prepared in the same way as in Example 1 except the following condition:
compound (3) (represented by general formula (I) in which exponent m=5, exponent n=5, chain end group: p-tert-butylphenyl, 62830 of viscosity average molecular weight) was used as a polycarbonate resin,
   thereby obtaining 509.3 g of a charge transporting layer coating liquid (88.4% yield).

### Example 4

In the preparation of a coating liquid for forming a charge transporting layer, a photoreceptor of Example 4 was prepared in the same way as in Example 1 except the following conditions:
an amount of the silica particles was changed from 10 g to 7 g and an amount of the tetrahydrofuran was changed from 56.7 g to 39.7 g so as to prepare a suspension;
an amount of the tetrahydrofuran to be poured into the wide-mouth bottle container was changed from 33.3 g to 23.3 g;
an amount of compound (A) of the charge transporting substance was changed from 37.5 g to 38.8 g;
54.3 g of compound (3) (represented by general formula (I) in which exponent m=4, exponent n=6, chain end group: p-tert-butylphenyl, 61156 of viscosity average molecular weight) was used as a polycarbonate resin;
an amount of the tetrahydrofuran was changed from 386.2 g to 413.7 g, thereby obtaining 537.0 g of a charge transporting layer coating liquid (93.1% yield).

### Example 5

In the preparation of a coating liquid for forming a charge transporting layer, a photoreceptor of Example 5 was prepared in the same way as in Example 1 except the following conditions:
an amount of the silica particles was changed from 10 g to 19 g and an amount of the tetrahydrofuran was changed from 56.7 g to 107.7 g so as to prepare a suspension;
an amount of the tetrahydrofuran to be poured into the wide-mouth bottle container was changed from 33.3 g to 63.3 g;
an amount of compound (A) of the charge transporting substance was changed from 37.5 g to 33.8 g;
47.3 g of compound (3) (represented by general formula (I) in which exponent m=4, exponent n=6, chain end group: p-tert-butylphenyl, 61156 of viscosity average molecular weight) was used as a polycarbonate resin;
an amount of the tetrahydrofuran was changed from 386.2 g to 305.7 g,
   thereby obtaining 538.0 g of a charge transporting layer coating liquid (93.3% yield).

### Example 6

In the preparation of a coating liquid for forming a charge transporting layer, a photoreceptor of Example 6 was prepared in the same way as in Example 1 except the following conditions:
52.5 g of compound (3) (represented by general formula (I) in which exponent m=5.5, exponent n=4.5, chain end group: p-tert-butylphenyl, 61200 of viscosity average molecular weight) was used as a polycarbonate resin;
silicone oil was not used,
   thereby obtaining 525.3 g of a charge transporting layer coating liquid (91.2% yield).

### Example 7

In the preparation of a coating liquid for forming a charge transporting layer, a photoreceptor of Example 7 was prepared in the same way as in Example 1 except the following condition:
compound (10) (represented by general formula (I) in which exponent m=5, exponent n=5, chain end group: 2,2-difluoro-2-(perfluorohexyloxy) ethoxy, 45020
of viscosity average molecular weight) was used as a polycarbonate resin,
   thereby obtaining 496.3 g of a charge transporting layer coating liquid (94.5% yield).

### Example 8

In the preparation of a coating liquid for forming a charge transporting layer, a photoreceptor of Example 8 was prepared in the same way as in Example 1 except the following conditions:
an amount of compound (A) of the charge transporting substance was changed from 37.5 g to 32.1 g;
57.9 g of compound (3) (represented by general formula (I) in which exponent m=4, exponent n=6, chain end group: p-tert-butylphenyl, 61156 of viscosity average molecular weight) was used as a polycarbonate resin;
an amount of the silicone oil was changed from 0.011 g to 0.012 g,
   thereby obtaining 496.3 g of a charge transporting layer coating liquid (94.5% yield).

### Example 9

In the preparation of a coating liquid for forming a charge transporting layer, a photoreceptor of Example 9 was prepared in the same way as in Example 1 except the following condition:
compound (8) (represented by general formula (I) in which exponent m=4, exponent n=6, chain end group: p-tert-butylphenyl, 59862 of viscosity average molecular weight) was used as a polycarbonate resin,
   thereby obtaining 521.1 g of a charge transporting layer coating liquid (90.4% yield).

### Example 10

In the preparation of a coating liquid for forming a charge transporting layer, a photoreceptor of Example 10 was prepared in the same way as in Example 1 except the following condition:
compound (4) (represented by general formula (I) in which exponent m=4, exponent n=6, chain end group: p-tert-butylphenyl, 60824 of viscosity average molecular weight) was used as a polycarbonate resin,
   thereby obtaining 513.6 g of a charge transporting layer coating liquid (89.1% yield).

### Example 11

In the preparation of a coating liquid for forming a charge transporting layer, a photoreceptor of Example 11 was prepared in the same way as in Example 1 except the following conditions:
an amount of compound (A) of the charge transporting substance was changed from 37.5 g to 39.1 g;
50.9 g of compound (3) (represented by general formula (I) in which exponent m=4, exponent n=6, chain end group: p-tert-butylphenyl, 61156 of viscosity average molecular weight) was used as a polycarbonate resin;
an amount of the silicone oil was changed from 0.011 g to 0.010 g,
   thereby obtaining 496.3 g of a charge transporting layer coating liquid (91.8% yield).

### Example 12

In the preparation of a coating liquid for forming a charge transporting layer, a photoreceptor of Example 12 was prepared in the same way as in Example 1 except the following conditions:
an amount of compound (A) of the charge transporting substance was changed from 37.5 g to 34.6 g;
55.4 g of compound (6) (represented by general formula (I) in which exponent m=5, exponent n=5, chain end group: p-tert-butylphenyl, 61942 of viscosity average molecular weight) was used as a polycarbonate resin,
   thereby obtaining 553.6 g of a charge transporting layer coating liquid (91.9% yield).

### Example 13

In the preparation of a coating liquid for forming a charge transporting layer, a photoreceptor of Example 13 was prepared in the same way as in Example 1 except the following conditions:
an amount of compound (A) of the charge transporting substance was changed from 37.5 g to 34.6 g;
55.4 g of compound (5) (represented by general formula (I) in which exponent m=5, exponent n=5, chain end group: p-tert-butylphenyl, 59600 of viscosity average molecular weight) was used as a polycarbonate resin,
   thereby obtaining 542.1 g of a charge transporting layer coating liquid (94.0% yield).

### Example 14

In the preparation of a coating liquid for forming a charge transporting layer, a photoreceptor of Example 14 was prepared in the same way as in Example 1 except the following conditions:
an amount of compound (A) of the charge transporting substance was changed from 37.5 g to 30.5 g;
59.5 g of compound (6) (represented by general formula (I) in which exponent m=5, exponent n=5, chain end group: p-tert-butylphenyl, 61942 of viscosity average molecular weight) was used as a polycarbonate resin;
an amount of the silicone oil was changed from 0.011 g to 0.012 g,
   thereby obtaining 553.2 g of a charge transporting layer coating liquid (96.0% yield).

### Example 15

In the preparation of a coating liquid for forming a charge transporting layer, a photoreceptor of Example 15 was prepared in the same way as in Example 1 except the following condition:
52.5 g of compound (6) (represented by general formula (I) in which exponent m=5, exponent n=5, chain end group: p-tert-butylphenyl, 61942 of viscosity average molecular weight) was used as a polycarbonate resin,
   thereby obtaining 543.2 g of a charge transporting layer coating liquid (94.2% yield).

### Example 16

In the preparation of a coating liquid for forming a charge transporting layer, a photoreceptor of Example 16 was prepared in the same way as in Example 1 except the following conditions:
silica particles (product name: AEROSIL™ R976, manufactured by NIPPON AEROSIL CO., LTD.; number average primary particle diameter of 7 nm; subjected to a dimethyldichlorosilane surface treatment) were used;
compound (3) (represented by general formula (I) in which exponent m=4, exponent n=6, chain end group: p-tert-butylphenyl, 61156 of viscosity average molecular weight) was used as a polycarbonate resin,
   thereby obtaining 486.1 g of a charge transporting layer coating liquid (84.4% yield).

### Example 17

In the preparation of a coating liquid for forming a charge transporting layer, a photoreceptor of Example 17 was prepared in the same way as in Example 1 except the following conditions:
silica particles (product name: AEROSIL™ NAX50, manufactured by NIPPON AEROSIL CO., LTD.; number average primary particle diameter of 30 nm; subjected to a hexamethyldisilazane surface treatment) were used;
compound (3) (represented by general formula (I) in which exponent m=4, exponent n=6, chain end group: p-tert-butylphenyl, 61156 of viscosity average molecular weight) was used as a polycarbonate resin,
   thereby obtaining 552.3 g of a charge transporting layer coating liquid (95.9% yield).

### Example 18

In the preparation of a coating liquid for forming a charge transporting layer, a photoreceptor of Example 18 was prepared in the same way as in Example 1 except the following conditions:
an amount of the silica particles was changed from 10 g to 14 g;
an amount of compound (A) of the charge transporting substance was changed from 37.5 g to 35.8 g;
50.2 g of compound (3) (represented by general formula (I) in which exponent m=5, exponent n=5, chain end group: p-tert-butylphenyl, 60800 of viscosity average molecular weight) was used as a polycarbonate resin;
the mixture was stirred for 30 seconds using a stirrer,
   thereby obtaining 499.6 g of a charge transporting layer coating liquid (86.7% yield).

### Example 19

In the preparation of a coating liquid for forming a charge transporting layer, a photoreceptor of Example 19 was prepared in the same way as in Example 1 except the following conditions:
15 g of the silica particles (product name: AEROSIL™ R974, manufactured by NIPPON AEROSIL CO., LTD.; number average primary particle diameter of 12 nm; subjected to a dimethyldichlorosilazane surface treatment) were used; and an amount of the tetrahydrofuran was changed from 56.7 g to 85.0 g so as to prepare a suspension;
an amount of the tetrahydrofuran to be poured into the wide-mouth bottle container was changed from 33.3 g to 50.0 g;
compound (3) (represented by general formula (I) in which exponent m=3, exponent n=7, chain end group: p-tert-butylphenyl, 42000 of viscosity average molecular weight) was used as a polycarbonate resin;
an amount of the tetrahydrofuran was changed from 386.2 g to 365.0 g,
   thereby obtaining 576.4 g of a charge transporting layer coating liquid (95.3% yield).

### Example 20

In the preparation of a coating liquid for forming a charge transporting layer, a photoreceptor of Example 20 was prepared in the same way as in Example 1 except the following conditions:
silica particles (product name: AEROSIL™ NAX50, manufactured by NIPPON AEROSIL CO., LTD.; number average primary particle diameter of 30 nm; subjected to a hexamethyldisilazane surface treatment) were used to prepare a suspension;
compound (3) (represented by general formula (I) in which exponent m=5.5, exponent n=4.5, chain end group: p-tert-butylphenyl, 64800 of viscosity average molecular weight) was used as a polycarbonate resin;
an amount of the tetrahydrofuran was changed from 386.2 g to 367.1 g;
1 the mixture obtained was subjected to 20-pass dispersion using a wet media-less atomizer,
   thereby obtaining 476.2 g of a charge transporting layer coating liquid (86.0% yield).

### Example 21

In the preparation of a coating liquid for forming a charge transporting layer, a photoreceptor of Example 21 was prepared in the same way as in Example 1 except the following condition:
compound (2) (represented by general formula (I) in which exponent m=4, exponent n=6, chain end group: p-tert-butylphenyl, 62300 of viscosity average molecular weight) was used as a polycarbonate resin,
   thereby obtaining 550.0 g of a charge transporting layer coating liquid (95.5% yield).

### Example 22

In the preparation of a coating liquid for forming a charge transporting layer, a photoreceptor of Example 22 was prepared in the same way as in Example 1 except the following conditions:
an amount of the silica particles was changed from 10 g to 19 g;
an amount of compound (A) of the charge transporting substance was changed from 37.5 g to 33.8 g;
47.3 g of compound (3) (represented by general formula (I) in which exponent m=3, exponent n=7, chain end group: p-tert-butylphenyl, 42000 of viscosity average molecular weight) was used as a polycarbonate resin,
   thereby obtaining 523.8 g of a charge transporting layer coating liquid (90.8% yield).

### Example 23

In the preparation of a coating liquid for forming a charge transporting layer, a photoreceptor of Example 23 was prepared in the same way as in Example 1 except the following conditions:
7 g of the silica particles (product name: AEROSIL™ R976, manufactured by NIPPON AEROSIL CO., LTD.; number average primary particle diameter of 7 nm;
subjected to a dimethyldichlorosilane surface treatment) were used;
compound (3) (represented by general formula (I) in which exponent m=4, exponent n=6, chain end group: p-tert-butylphenyl, 61156 of viscosity average molecular weight) was used as a polycarbonate resin,
   thereby obtaining 527.0 g of a charge transporting layer coating liquid (94.3% yield).

### Comparative Example 1

In the preparation of a coating liquid for forming a charge transporting layer, a photoreceptor of Comparative Example 1 was prepared in the same way as in Example 1 except the following condition:
compound (3) (represented by general formula (I) in which exponent m=1, exponent n=9, chain end group: p-tert-butylphenyl, 59400 of viscosity average molecular weight) was used as a polycarbonate resin,
   thereby obtaining 554.9 g of a charge transporting layer coating liquid (96.3% yield).

### Comparative Example 2

In the preparation of a coating liquid for forming a charge transporting layer, a photoreceptor of Comparative Example 2 was prepared in the same way as in Example 1 except the following condition:
compound (3) (represented by general formula (I) in which exponent m=5.6, exponent n=4.4, chain end group: p-tert-butylphenyl, 59942 of viscosity average molecular weight) was used as a polycarbonate resin,
   thereby obtaining 478.1 g of a charge transporting layer coating liquid (83.0% yield).

### Comparative Example 3

In the preparation of a coating liquid for forming a charge transporting layer, a photoreceptor of Comparative Example 3 was prepared in the same way as in Example 1 except the following conditions:
silica particles were not used;
an amount of compound (A) of the charge transporting substance was changed from 37.5 g to 34.5 g;
65.5 g of compound (3) (represented by general formula (I) in which exponent m=5.5, exponent n=4.5, chain end group: p-tert-butylphenyl, 61200 of viscosity average molecular weight) was used as a polycarbonate resin;
an amount of the silicone oil was changed from 0.011 g to 0.013 g;
an amount of the tetrahydrofuran was changed from 386.2 g to 476.2 g,
   thereby obtaining 568.1 g of a charge transporting layer coating liquid (98.6% yield).

### Comparative Example 4

In the preparation of a coating liquid for forming a charge transporting layer, a photoreceptor of Comparative Example 4 was prepared in the same way as in Example 1 except the following conditions:
silica particles (product name: AEROSIL™ VPRY40S, manufactured by NIPPON AEROSIL CO., LTD.; number average primary particle diameter from 80 to 100 nm;
subjected to a dimethyldichlorosilazane surface treatment) were used;
compound (3) (represented by general formula (I) in which exponent m=4, exponent n=6, chain end group: p-tert-butylphenyl, 61156 of viscosity average molecular weight) was used as a polycarbonate resin,
   thereby obtaining 553.5 g of a charge transporting layer coating liquid (96.0% yield).

### Comparative Example 5

In the preparation of a coating liquid for forming a charge transporting layer, a photoreceptor of Comparative Example 5 was prepared in the same way as in Example 1 except the following conditions:
an amount of the silica particles was changed from 10 g to 5 g and an amount of the tetrahydrofuran was changed from 56.7 g to 28.3 g so as to prepare a suspension;
an amount of the tetrahydrofuran to be poured into the wide-mouth bottle container was changed from 33.3 g to 16.7 g;
an amount of compound (A) of the charge transporting substance was changed from 37.5 g to 39.6 g;
55.4 g of compound (3) (represented by general formula (I) in which exponent m=4, exponent n=6, chain end group: p-tert-butylphenyl, 61156 of viscosity average molecular weight) was used as a polycarbonate resin;
compound (3) (represented by general formula (I) in which exponent m=4, exponent n=6, chain end group: p-tert-butylphenyl, 61156 of viscosity average molecular weight) was used as a polycarbonate resin;
an amount of the tetrahydrofuran was changed from 386.2 g to 431.2 g,
   thereby obtaining 556.2 g of a charge transporting layer coating liquid (96.5% yield).

### Comparative Example 6

In the preparation of a coating liquid for forming a charge transporting layer, a photoreceptor of Comparative Example 6 was prepared in the same way as in Example 1 except the following conditions:
an amount of the silica particles was changed from 10 g to 21 g and an amount of the tetrahydrofuran was changed from 56.7 g to 119.0 g so as to prepare a suspension;
an amount of the tetrahydrofuran to be poured into the wide-mouth bottle container was changed from 33.3 g to 70.0 g;
an amount of compound (A) of the charge transporting substance was changed from 37.5 g to 32.9 g;
46.1 g of compound (3) (represented by general formula (I) in which exponent m=4, exponent n=6, chain end group: p-tert-butylphenyl, 61156 of viscosity average molecular weight) was used as a polycarbonate resin;
an amount of the silicone oil was changed from 0.011 g to 0.009 g;
an amount of the tetrahydrofuran was changed from 386.2 g to 287.2 g,
   thereby obtaining 482.3 g of a charge transporting layer coating liquid (83.7% yield).

### Comparative Example 7

In the preparation of a coating liquid for forming a charge transporting layer, a photoreceptor of Comparative Example 7 was prepared in the same way as in Example 1 except the following conditions:
19 g of the silica particles (product name: AEROSIL™ R976, manufactured by NIPPON AEROSIL CO., LTD.; number average primary particle diameter from 7 nm; subjected to a dimethyldichlorosilane surface treatment) was used and an amount of the tetrahydrofuran was changed from 56.7 g to 107.7 g so as to prepare a suspension;
an amount of the tetrahydrofuran to be poured into the wide-mouth bottle container was changed from 33.3 g to 63.3 g;
an amount of compound (A) of the charge transporting substance was changed from 37.5 g to 33.8 g;
47.3 g of compound (3) (represented by general formula (I) in which exponent m=4, exponent n=6, chain end group: p-tert-butylphenyl, 61156 of viscosity average molecular weight) was used as a polycarbonate resin;
an amount of the silicone oil was changed from 0.011 g to 0.009 g;
an amount of the tetrahydrofuran was changed from 386.2 g to 305.7 g;
the mixture obtained was subjected to 12-pass dispersion using a wet media-less atomizer,
   thereby obtaining 470.4 g of a charge transporting layer coating liquid (81.6% yield).

### Comparative Example 8

In the preparation of a coating liquid for forming a charge transporting layer, a photoreceptor of Comparative Example 8 was prepared in the same way as in Example 1 except the following conditions:
7 g of the silica particles (product name: AEROSIL™ NAX50, manufactured by NIPPON AEROSIL CO., LTD.; number average primary particle diameter from 30 nm; subjected to a hexamethyldisilazane surface treatment) was used and an amount of the tetrahydrofuran was changed from 56.7 g to 39.7 g so as to prepare a suspension;
an amount of the tetrahydrofuran to be poured into the wide-mouth bottle container was changed from 33.3 g to 23.3 g;
an amount of compound (A) of the charge transporting substance was changed from 37.5 g to 38.8 g;
54.3 g of compound (3) (represented by general formula (I) in which exponent m=4, exponent n=6, chain end group: p-tert-butylphenyl, 61156 of viscosity average molecular weight) was used as a polycarbonate resin;
an amount of the tetrahydrofuran was changed from 386.2 g to 413.7 g,
   thereby obtaining 553.2 g of a charge transporting layer coating liquid (95.9% yield).

### Comparative Example 9

In the preparation of a coating liquid for forming a charge transporting layer, a photoreceptor of Comparative Example 9 was prepared in the same way as in Example 1 except the following conditions:
an amount of compound (A) of the charge transporting substance was changed from 37.5 g to 38.8 g;
54.3 g of compound (1) (represented by general formula (I) in which exponent m=5.5, exponent n=4.5, chain end group: p-tert-butylphenyl, 62540 of viscosity average molecular weight) was used as a polycarbonate resin;
an amount of the tetrahydrofuran was changed from 386.2 g to 401.0 g,
   thereby obtaining 562.3 g of a charge transporting layer coating liquid (94.7% yield).

### Comparative Example 10

In the preparation of a coating liquid for forming a charge transporting layer, a photoreceptor of Comparative Example 10 was prepared in the same way as in Example 1 except the following condition:
52.5 g of compound (11) (represented by general formula (I) in which exponent m=3, exponent n=7, chain end group: F1, 62500 of viscosity average molecular weight) was used as a polycarbonate resin,
   thereby obtaining 521.0 g of a charge transporting layer coating liquid (90.4% yield).

### Evaluations

The photoreceptors prepared in Examples 1 to 23 and Comparative Examples 1 to 10 were evaluated for the following characteristics: (1) print resistance, (2) sensitivity characteristics, (3) adhesion, and (4) blade curling; and an overall evaluation was made based on the results obtained.

### (1) Print Resistance

The photoreceptors prepared to be evaluated were each installed in a unit of a digital copier (model: BP-40C26, manufactured by SHARP CORPORATION) remodeled for testing; a developing device was attached; and the pressure at which the cleaning blade of the cleaner contacts the photoreceptor—a so—called cleaning blade pressure—was adjusted to 21 gf/cm (2.05×10⁻¹ N/cm: initial linear pressure). A print resistance test was conducted by printing a character test chart (ISO 19752) on 300,000 sheets of recording paper in an environment where the temperature is 35° C. and the relative humidity is 85%.

A thickness of the photoreceptive layers each was measured at the start of the print resistance test and after the image formation on the 300,000 sheets of recording paper by using a film thickness measurement instrument (model: F-20-EXR, manufactured by Filmetrics, Inc.). From the difference between the thickness of the photoreceptive layer at the start of the print resistance test and the thickness thereof after the image formation on the 300,000 sheets of recording paper, an amount of film loss per 100,000 revolutions of the photoreceptor drum was determined; and the print resistance was evaluated from the obtained film loss amount with reference to the following criteria.

It was evaluated that the greater the film loss amount, the worse the print resistance (printing resistance).

### Evaluation Criteria

VG: film loss amount <0.70 μm/100,000 revolutions
   The photoreceptors can be used without any problem even in a multifunction peripheral or a printer that are required to have long life.
G: 0.70 μm/100,000 revolutions≤film loss amount <1.00 μm/100,000 revolutions
   The photoreceptors can be used without any problem, despite having a slightly high amount of film loss, as long as being used in a multifunction peripheral or a printer that are not required to have long life.
NB: 1.00 μm/100,000 revolutions≤film loss amount <1.50 μm/100,000 revolutions
   The photoreceptors can be used without any problem, despite having a high amount of film loss, as long as being used in a low-priced multifunction peripheral or printer.
B: 1.50 μm/100,000 revolutions≤film loss amount
   Problematic in actual use because of a high amount of film loss

### (2) Sensitivity Characteristics

The photoreceptors prepared to be evaluated were each installed in a unit of a digital copier (model: BP-40C26, manufactured by SHARP CORPORATION) remodeled for testing; and the developing device was removed from the digital copier; instead of the developing device, a surface electrometer (model: MODEL 344, manufactured by Trek Japan K.K.) was attached at a developing site of the digital copier. In an environment where the temperature is 35° C. and the relative humidity is 85%, an initial residual potential and a surface potential of the photoreceptors after current fatigue were measured; and these differences ΔVr (V) were used as evaluation criteria, which will be described below, to evaluate sensitivity stability of the photoreceptors as an index of sensitivity deterioration caused by repeated use of the photoreceptors.

### Evaluation Criteria

VG: ΔVr<40
   The photoreceptors can be used without any problem even in a high-speed multifunction peripheral or printer that are required to have high sensitivity.
G: 40≤ΔVr<80
   The photoreceptors can be used without any problem in a low-speed to middle-speed multifunction peripheral or printer.
NB: 80≤ΔVr<140
   The photoreceptors can be used without any problem, despite having a slightly low density, in a low-speed and low-priced multifunction peripheral or printer.
B: 140≤ΔVr

Due to poor sensitivity, density was low, which is problematic in actual use.

### (3) Adhesion

A surface of each photoreceptor (drum) to be evaluated was scratched (nicked) with a cutter knife (utility knife) in a grid pattern at a pitch of 1 mm in a 10 mm square. Next, adhesive tape (product name: Nichiban Cellotape™, manufactured by NICHIBAN Co., Ltd.) was applied on the scratches, and this adhesive tape was peeled off instantaneously to evaluate adhesion of the photoreceptors with reference to the following criteria.

### Evaluation Criteria

VG: A peeled portion of the photoreceptive layer is within 5% of a total square area. The photoreceptors can be used without any problem even in a high-speed multifunction peripheral or printer that are required to have sensitivity.
G: A width of a peeling caused by the scratches is wider than 4 points; and the peeled portion is more than 5% of the total square area but less than 35% of the total square area.
   The photoreceptors can be used without any problem in a medium-speed to low-speed multifunction peripheral or printer.
NB: A width of a peeling caused by the scratches is wider than 4 points; and the peeled portion is 35% or more of the total square area but less than 65% of the total square area.
   The photoreceptors can be used without any problem, despite having a slightly low density, in a low-speed and low-priced multifunction peripheral or printer.
B: A peeled portion of the photoreceptive layer caused by the peeling is 65% or more of the total square area.
   Due to poor sensitivity, density is low, which is problematic in actual use.

### (4) Blade Curling

The photoreceptors to be evaluated were each installed in a unit of a digital copier (model: MX-M3531, manufactured by SHARP CORPORATION) remodeled for testing; and a resistance test (print resistance test) was conducted by printing a character test chart (ISO 19752) on 80K (80,000) sheets of recording paper in an environment of 35° C. temperature/80% relative humidity (normal temperature/normal humidity), and resistance to blade turn-up (durability to blade curling) was evaluated. If blade turn-up occurred after 30K (30,000) sheets or 60K (60,000) sheets were printed, the test was stopped at that point.

### Evaluation Criteria

VG: No blade curling occurs after 80K (80,000) sheets were printed.
   Extremely good resistance to blade curling.
G: No blade turn-up occurs after 60K (60,000) sheets were printed; however, blade turn-up occurs before 80K (80,000) sheets were printed.
   Good resistance to blade curling.
NB: No blade turn-up occurs after 30K (30,000) sheets were printed; however, blade turn-up occurs before 60K (60,000) sheets were printed.
   Not a problem in actual use.
B: Blade turn-up occurs after 30K (30,000) sheets were printed.
   Risky situation for long-life use.

### (5) Overall Evaluation

Based on the above evaluation results, an overall evaluation was made with reference to the following criteria.

### Evaluation Criteria

VG: All items are VG rated, leading to be rated very good.
   The photoreceptors can be used without any problem even in a multifunction peripheral or a printer that are required to have long life and high image quality.
G: Some of the items are G rated; however, all items are rated G or higher.
   The photoreceptors can be used without any problem, as long as being used in a multifunction peripheral or a printer that are not required to have long life and high image quality.
NB: Some of the items are NB rated; however, all items are rated NB or higher.
   The photoreceptors can be used without any problem, as long as being used in a low-priced multifunction peripheral or printer.
B: Some of the items are B rated, and actual use of the photoreceptors is not possible.
   Due to poor sensitivity, density is low, which is problematic in actual use.

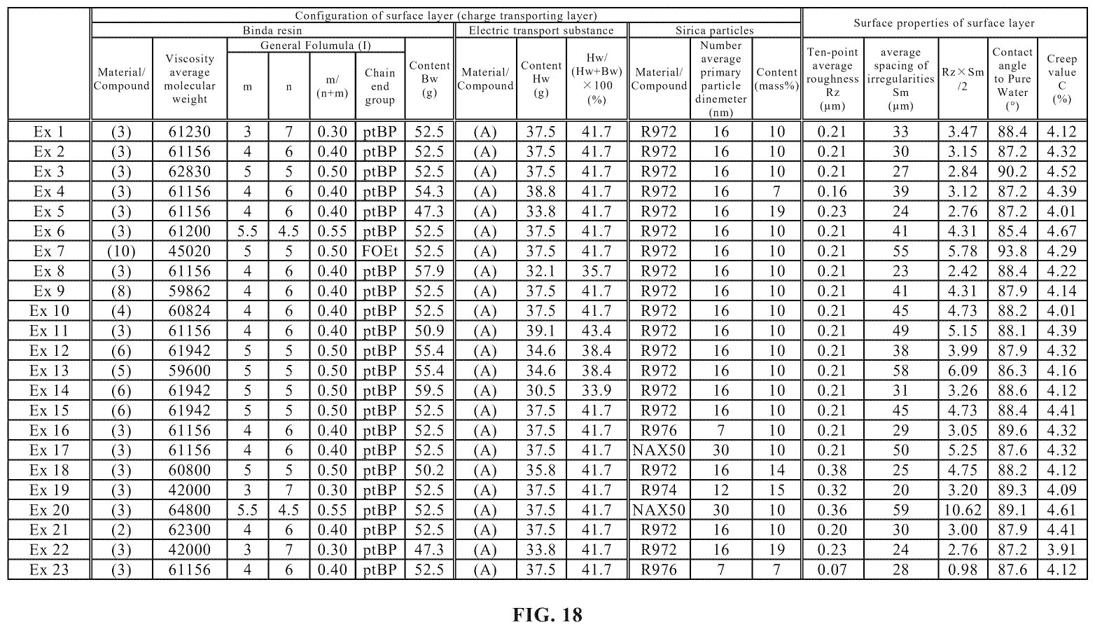

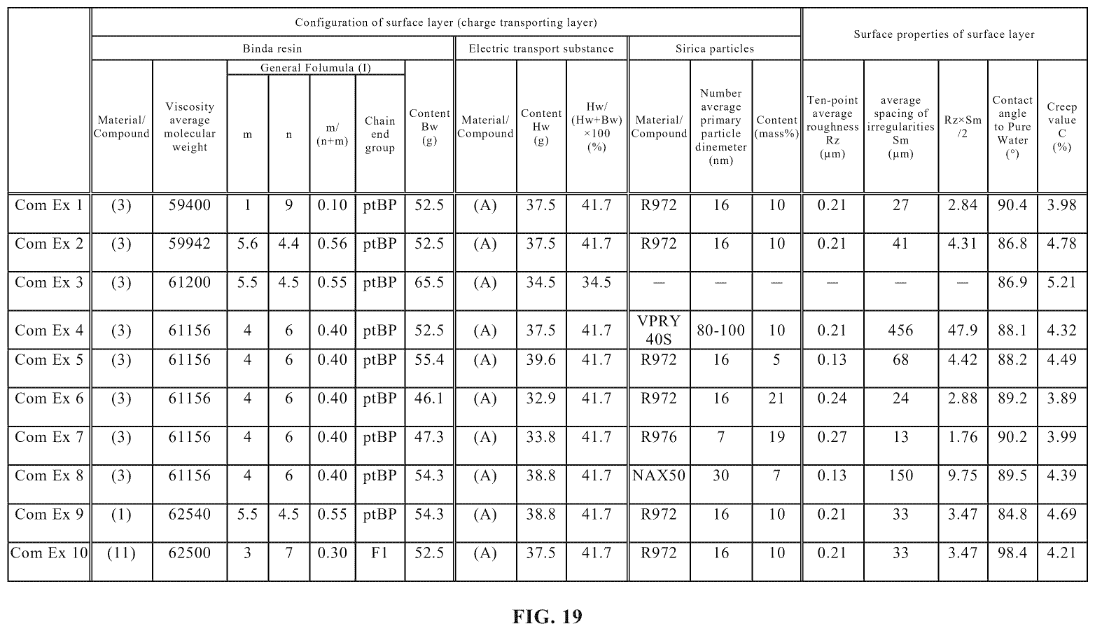

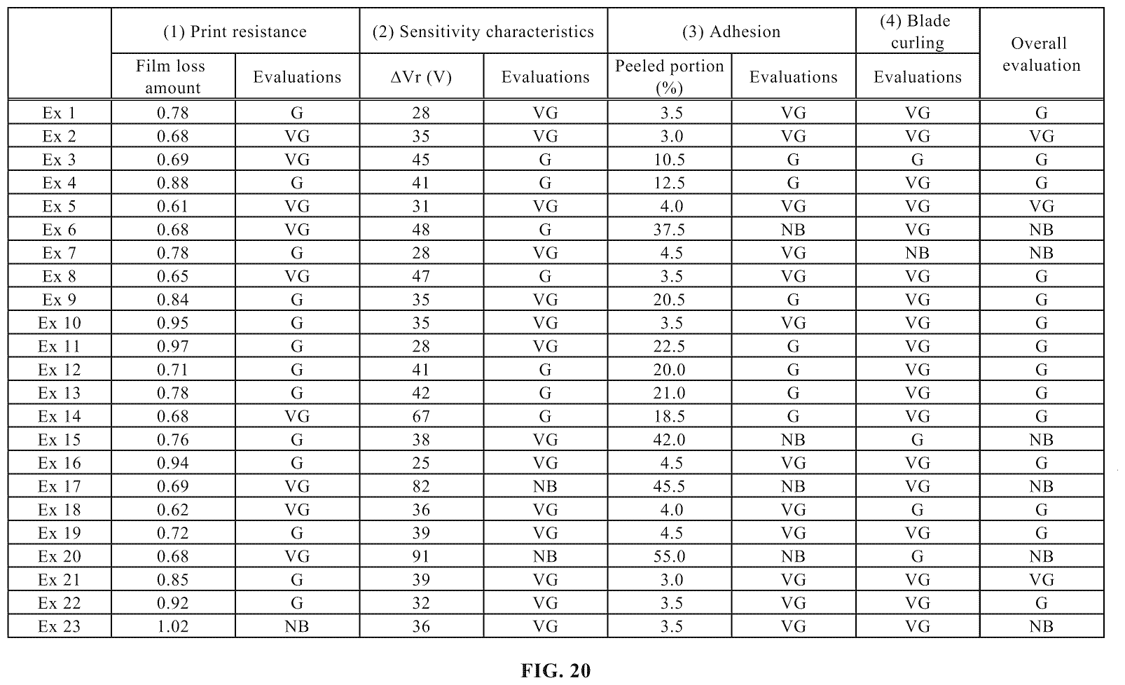

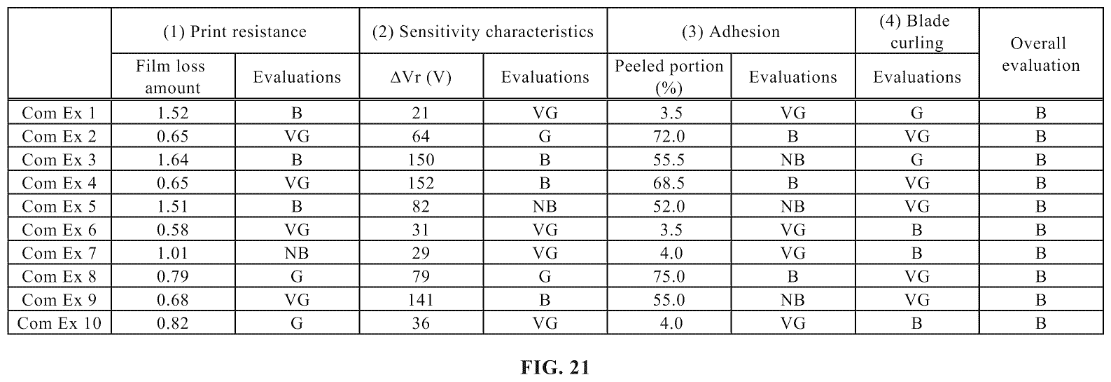

Main constituent materials for the surface layer (charge transporting layer) of each photoreceptor and their physical properties as well as surface properties of the surface layer are shown in FIGS. 18 and 19, and the evaluation results of each photoreceptor are shown in FIGS. 20 and 21.

The abbreviations (shown in Tables 2 and 3) of the chain end groups of the binder resin are spelled out as follows:
ptBP: p-tert-butylphenyl
FOEt: 2,2-difluoro-2-(perfluorohexyloxy) ethoxy
F1: fluorine-containing aliphatic group F1

The following can be found from Tables 2 to 5.

It can be found that the photoreceptors of Examples 1 to 23, which satisfy the constituent requirements according to the present disclosure, are evaluated as excellent in terms of print resistance, increase in residual potential due to repeated fatigue, adhesion, and blade curling, whereas the photoreceptors of Comparative Examples 1 to 10, which do not satisfy the constituent requirements according to the present disclosure, are inferior to the former. These differences are believed to be due to the following reasons: insufficient dispersion of the silica particles in the photoreceptive layer of the photoreceptors; problems with the structure of the binder resin; and problems caused by changes in surface lubricity in the axial direction of the photoreceptors due to the repeated use.

In other words, the photoreceptors according to the present disclosure is believed to be able to maintain high print resistance while improving adhesion between the constituent layers of the photoreceptors, particularly between the charge generating layer, which is the underlying layer, and the charge transporting layer, which is the upper layer, in the case of a laminated photoreceptor layer, and also is believed to be able to suppress an increase in residual potential and blade curling (blade wrinkles), thereby obtaining stable image characteristics over a long period of time.

It can be seen that an increase in the content of the silica particles in the photoreceptive layer suppresses the adhesion of the photoreceptive layer and the increase in Vr due to repeated use (Example 2, Example 4, and Comparative Example 3).

It can be seen that when structural unit (A) of general formula (I) of the polycarbonate resin is structural unit (A1), and the former is the same in silica content as the latter, the photoreceptors, in which the mass Bw of the binder resin in the surface layer of the photoreceptive layer and the mass Hw of the low molecular weight component having a molecular weight of 1,000 or less satisfy the relationship 38.2≤Hw/(Hw+Bw)×100≤43.0, maintain print resistance while suppressing the adhesion of the photoreceptive layer and the increase in Vr caused by repeated use (Example 2, Example 4, and Example 8).

It can be seen that as the value of the above relational equation (3) becomes larger—in other words, as the content of the binder resin in the surface layer of the photoreceptive layer is reduced—the adhesion deteriorates (Example 11).

It can be seen that as the value of the above relational equation (3) becomes smaller, the adverse effect of the increase in residual potential becomes greater (Example 8).

It can be seen that the photoreceptor (Example 2) that meets the following conditions:
the substituents R11 and R12 in general formula (I) of the polycarbonate resin are the same substituents, and the substituents R21 and R22 are the same substituents; and
either R11 or R12 or either R21 or R22 is a hydrogen atom has superior print resistance to the photoreceptors (Example 9 and Example 10) that do not satisfy these conditions.

It can be seen that the photoreceptor, in which structural unit (B) of general formula (I) of the polycarbonate resin in the above (6) is structural unit (B1), has an advantage in terms of print resistance compared to the photoreceptor (Example 21) that does not satisfy this condition.

When comparing the photoreceptor (Example 3), in which structural unit (B) of general formula (I) of the polycarbonate resin is structural unit (B1), with the photoreceptors (Examples 12 to 15), in which structural unit (B1) is structural unit (B2), it is found that the former is superior in print resistance and mechanical fatigue, while the latter are superior in preventing blade curling and also tend to be favorable against electrical fatigue. This is presumably because the imbalance in lubrication in the axial direction of the latter photoreceptors became better than the former photoreceptor, thereby suppressing blade turn-up (blade warping).

As for Hw/(Hw+Bw)×100, as is described in (3) above, it can be found that structural unit (B2) of general formula (I) of the polycarbonate resin of the latter photoreceptors is susceptible to mechanical fatigue; therefore, the ratio should be set lower overall for a better balance of properties.

It can be found that the photoreceptor (Example 17) having a large number average primary particle diameter of the silica particles tends to have good print resistance, while the photoreceptor (Example 16) having a small number average primary particle diameter tends to have good adhesion and sensitivity characteristics; and the photoreceptor (Example 2) having a number average primary particle diameter of 10 to 20 nm tends to have a good balance of the characteristics seen in the former photoreceptor and the latter photoreceptor.

In comparison with the photoreceptors (Examples 1 to 3), in which the ten-point average roughness Rz of the surface of the surface layer of the photoreceptors is 0.10 to 0.30 μm, and the ten-point average roughness Rz and the average spacing Sm of the irregularities satisfy the relationship Rz×Sm/2≤10, the photoreceptors (Examples 18 to 20), in which Rz exceeds 0.30 μm, are found to have more convex portions due to silica on the surface of the photoreceptive layer, with the result that the irregularities of the surface of the photoreceptive layer of the latter become increasingly larger due to repeated fatigue, thereby making it easier for imbalances in lubrication in the axial direction of the photoreceptive layer of the latter to occur, and thus increasing a risk of blade turn-up (blade warping); and in particular, when the above-mentioned Rz×Sm/2 exceeds 10 and becomes large, the dispersion state of silica in the photoreceptive layer tends to decrease, and adhesion tends to decrease (Example 20).

The photoreceptor (Example 7), in which the chain end group of general formula (I) of the polycarbonate resin is a monovalent fluorine-containing aliphatic group, has better adhesion to the underlying layer of the photoreceptive layer than the photoreceptor (Example 3), in which the chain end group is a monovalent aromatic group; and the former is capable of suppressing an increase in residual potential. In the meanwhile, it is found that the surface of the photoreceptive layer of the former becomes high in contact angle to pure water, with the result that an imbalance in lubrication of the photoreceptor surface caused by long-term use is likely to occur in the axial direction, which is likely to be unfavorable for blade curling; however, it is found that this is effective in cases where the photoreceptor life is set short.

It is found that when the content of the silica particles is less than 7 mass % in the photoreceptive layer, the print resistance tends to be slightly deteriorated, and there is a tendency for the photoreceptive layer surface to become more scratched after 100,000 revolutions, which results in a decrease in solvent crack resistance after the print resistance test (Comparative Example 5).

If the content of the silica particles exceeds 20% in the photoreceptive layer, there is a tendency for print resistance to improve; however, it is also found that if chemically deteriorated products adhere to the photoreceptive layer surface, and the photoreceptive layer surface is difficult to be refreshed, the binder resin is cut (cleaved) due to mechanical and/or electrical fatigue of the photoreceptive layer, and polar groups of a resin skeleton appear on the surface, and also the wettability of the photoreceptive layer surface is reduced, thereby diminishing solvent crack resistance and light resistance (Comparative Example 6).

What is claimed is:

1. An electrophotographic photoreceptor having at least a photoreceptive layer, which comprises one or more layers, on a conductive base,
wherein a surface layer of the photoreceptive layer contains a binder resin and silica particles,
wherein the silica particles have a number average primary particle diameter of 30 nm or less, and are contained at a ratio of 7 to 20 mass % with respect to a total solid content in the surface layer,
wherein the binder resin is made of a polycarbonate resin represented by general formula (I) comprising structural units (A) and (B) as below: 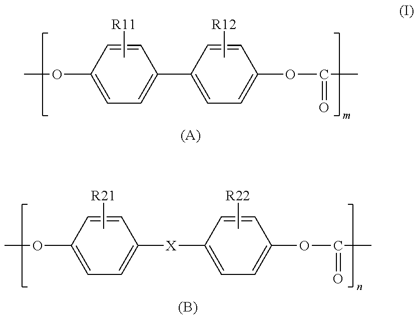
wherein R11, R12, R21, and R22 are identically or independently a hydrogen atom, an alkyl group having 1 to 3 carbon atoms, or a fluoroalkyl group having 1 to 3 carbon atoms; X is a phenylene group, a biphenylene group, a naphthylene group, an alkylene group having 1 to 3 carbon atoms, or a cycloalkylene group having 3 to 6 carbon atoms; and m and n are exponents that satisfy the relationship 0.3≤m/(n+m)≤0.55,
wherein a 4 mm-wide area at a center part of a charged area in an axial direction of the electrophotographic photoreceptor on the surface of the surface layer of the photoreceptive layer has an average spacing Sm of irregularities of 15 to 60 μm as defined in JIS-B-0601 (1994),
wherein the surface of the surface layer of the photoreceptive layer has a contact angle of 85 to 94° to pure water.

2. The electrophotographic photoreceptor according to claim 1, wherein structural unit (A) of the polycarbonate resin is structural unit (A1) represented by the following formula: 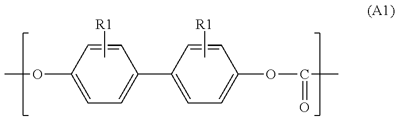
wherein R1 is a hydrogen atom, an alkyl group having 1 or 2 carbon atoms, or a fluoroalkyl group having 1 or 2 carbon atoms,
wherein a mass Bw and a mass Hw of a low molecular weight component having a molecular weight of 1,000 or less in the binder resin in the surface layer of the photoreceptive layer satisfy the relationship 38.2≤Hw/(Hw+Bw)×100≤43.0.

3. The electrophotographic photoreceptor according to claim 1, wherein structural unit (B) of the polycarbonate resin is structural unit (B1) represented by the following formula: 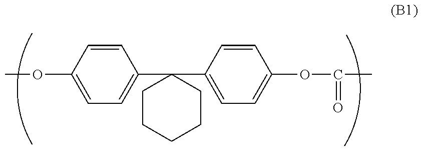
or structural unit (B2) represented by the following formula:

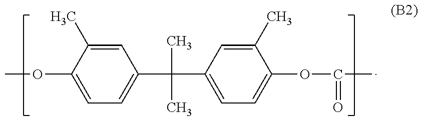

4. The electrophotographic photoreceptor according to claim 3, wherein each of the substituents R11 and R12 of structural unit (A) in the polycarbonate resin is a hydrogen atom;
and structural unit (B) in the polycarbonate resin is structural unit (B2),
wherein the mass Bw and the mass Hw of the low molecular weight component with a molecular weight of 1,000 or less in the binder resin in the surface layer of the photoreceptive layer satisfy the relationship 34≤Hw/(Hw+Bw)×100≤41.

5. The electrophotographic photoreceptor according to claim 1, wherein R11 and R12 in general formula (I) of the polycarbonate resin are the same substituent; R21 and R22 are the same substituent; and either R11 or R21 is a hydrogen atom.

6. The electrophotographic photoreceptor according to claim 1, wherein the silica particles have a number average primary particle diameter of 10 to 20 nm.

7. The electrophotographic photoreceptor according to claim 1, wherein the 4 mm-wide area at the center part of the charged area in the axial direction of the electrophotographic photoreceptor on the surface of the surface layer of the photoreceptive layer has a ten-point average roughness Rz of 0.10 to 0.30 μm as defined in JIS-B-0601 (1994); and the ten-point average roughness Rz and the average spacing Sm of the irregularities satisfy the relationship Rz×Sm/2≤10.

8. The electrophotographic photoreceptor according to claim 1, wherein the polycarbonate resin has chain end groups, each of the chain end groups being formed of a monovalent aromatic group.

9. The electrophotographic photoreceptor according to claim 1, wherein the surface layer of the photoreceptive layer has a creep value C of 4.0% or higher, as measured by applying a maximum indentation load of 30 mN for 5 seconds using a Vickers square-based diamond indenter with an opposing angle of 136° in an environment where the temperature is 25° C. and the relative humidity is 50%.

10. An image-forming apparatus comprising at least: the electrophotographic photoreceptor according to claim 1; an electrifier for electrifying the electrophotographic photoreceptor; an exposer for exposing the electrified electrophotographic photoreceptor to form an electrostatic latent image; a developer for developing the electrostatic latent image to form a toner image; and a transferer for transferring the toner image onto a recording medium.
